(19) United States
(12) Patent Application Publication
(10) Pub. No.: US 2013/0124321 A1
(43) Pub. Date: May 16, 2013

(54) ADVERTISEMENT DELIVERY SYSTEM, STORE TERMINAL AND COMPUTER-READABLE STORAGE MEDIUM

(71) Applicants: Kazuyasu Yamane, Tokyo (JP); Tatsuzi Ichikawa, Kawagoe-shi (JP)

(72) Inventors: Kazuyasu Yamane, Tokyo (JP); Tatsuzi Ichikawa, Kawagoe-shi (JP)

(73) Assignee: CASIO COMPUTER CO., LTD., Tokyo (JP)

(21) Appl. No.: 13/668,529

(22) Filed: Nov. 5, 2012

(30) Foreign Application Priority Data
Nov. 11, 2011 (JP) 2011-247881
Dec. 6, 2011 (JP) 2011-266894

(51) Int. Cl. G06Q 30/02

(52) U.S. Cl. 705/14.57; 705/14.64; 705/14.61; 705/14.58

(57) ABSTRACT

An advertisement delivery system of the present invention includes a store terminal, a management device connected to the store terminal via a communication network, and a mobile terminal connected to the management device via the communication network. The store terminal transmits a delivery instruction to the management device in response to an operation giving an instruction to deliver advertisement data. When the delivery instruction transmitted from the store terminal is received, the management device push-delivers the advertisement data of the store that has given the delivery instruction to the mobile terminal. Then, when the advertisement data of the store push-delivered from the management device is received, the mobile terminal judges whether or not the distance from the store to its current position is within a predetermined range, and outputs the advertisement data on a condition that the distance is within the predetermined range.

This application is based upon and claims the benefit of priority from the prior Japanese Patent Applications No. 2011-247881, filed Nov. 11, 2011 and No. 2011-266894, filed Dec. 6, 2011, the entire contents of which are incorporated herein by reference.

### BACKGROUND OF THE INVENTION

1. Field of the Invention

The present invention relates to an advertisement delivery system, a store terminal and a computer-readable storage medium by which store advertisement data is transmitted via a communication network.

2. Description of the Related Art

Generally, stores such as eating and drinking establishments including restaurants and pubs advertise using posters and banners in addition to distributing flyers near the stores or inserting them in newspapers. However, there are problems in these advertising methods in that labor and advance preparation are required and real-time information is not included in their advertisements because these advertisements show only information on upcoming events and the current status of the stores are not reflected therein.

Also, when advertising using digitalized data, these stores use their websites on the Internet or e-mail services for members. In these advertising methods, although real-time information can be given, the stores do not know whether or not their advertisements have been viewed, or whether or not targeted potential customers have viewed these advertisements. Therefore it is questionable whether the advertisements are effective.

Moreover, although the e-mail advertisements can be sent to each individual, they can only be sent to members, which could be annoying if they are sent frequently.

As a conventional technology for advertising to potential customers to enhance advertising effects, for example, a technology is known in which a search server acquires the positional information of a mobile terminal and transmits, to the mobile terminal, the surrounding area information of the cell in which the mobile terminal is positioned or the surrounding area information of nearby cells (refer to Japanese Patent Application Laid-Open (Kokai) Publication No. 11-285053). Also, a technology is known in which a server provides the advertisement information of stores near the user of a communication terminal (mobile terminal) in the order of proximity of the stores to the user (refer to Japanese Patent No. 4134229).

However, the technologies in the above-described patent documents are to provide advertisement information of nearby stores in response to a request from the user of a mobile terminal (advertisement recipient). Therefore, in these technologies, stores cannot advertise unless the user of a mobile terminal makes a request. As a result, these stores have to advertise reactively, which raises a question as to the customer attraction effect of these technologies.

### SUMMARY OF THE INVENTION

An object of the present invention is to actualize an advertisement having a high customer attraction effect which is transmitted at an appropriate timing based on the status of a store.

In order to achieve the above-described object, in accordance with one aspect of the present invention, there is provided an advertisement delivery system that transmits advertisement data of a store via a communication network, comprising: a store terminal; a management device connected to the store terminal via the communication network; and a mobile terminal connected to the management device via the communication network, wherein the store terminal comprises a transmitting section which transmits a delivery instruction to the management device in response to an operation giving an instruction to deliver advertisement data, wherein the management device comprises a delivering section which push-delivers to the mobile terminal the advertisement data of the store giving the delivery instruction, when the delivery instruction transmitted from the store terminal is received, and wherein the mobile terminal comprises a judging section which judges whether a distance from the store giving the delivery instruction to a current position of the mobile terminal is within a predetermined range, when the advertisement data of the store giving the delivery instruction which has been push-delivered from the management device is received, and an outputting section which outputs the advertisement data on a condition that the judging section has judged that the distance is within the predetermined range.

In accordance with another aspect of the present invention, there is provided a store terminal comprising: a connecting section which communicably connects with a management device that delivers advertisement data of a store to a mobile terminal via a communication network; a first transmitting section which transmits to the management device a delivery instruction giving an instruction to push-deliver the advertisement data to the mobile terminal in response to an instruction operation giving an instruction to deliver the advertisement data of the store; and a second transmitting section which transmits to the management device a delivery instruction giving an instruction to deliver information required for judgment to the mobile terminal that judges whether a distance from the store to a current position is within a predetermined range and outputs the advertisement data on a condition that the distance is within the predetermined range, when the delivery instruction for the advertisement data transmitted from the first transmitting section is received via the management device.

In accordance with another aspect of the present invention, there is provided a non-transitory computer-readable storage medium having stored thereon a program that is executable by a computer, the program being executable by the computer to perform functions comprising: processing for communicably connecting with a management device that delivers advertisement data of a store to a mobile terminal via a communication network; processing for transmitting to the management device a delivery instruction giving an instruction to push-deliver the advertisement data to the mobile terminal in response to an instruction operation giving an instruction to deliver the advertisement data of the store; and processing for transmitting to the management device a delivery instruction giving an instruction to deliver information required for judgment to the mobile terminal that judges whether a distance from the store to a current position is within a predetermined range and outputs the advertisement data on a condition that the distance is within the predetermined range, when the transmitted delivery instruction for the advertisement data of the store is received via the management device.

According to the present invention, an advertisement having a high customer attraction effect that is transmitted at an appropriate timing based on the status of a store can be actualized. Thus, the present invention is highly useful.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the overall structure of an advertisement delivery system that transmits store advertisement data via a communication network;

FIG. 2 is a block diagram showing basic components of a service provider-side management device 1;

FIG. 3 is a block diagram showing basic components of a store terminal 3;

FIG. 4 is a block diagram showing basic components of an advertisement recipient-side mobile terminal 5;

FIG. 5A is a diagram for describing a member store database 1A provided on the management device 1 side, and FIG. 5B is a diagram for describing a member database 1B provided on the management device 1 side;

FIG. 6A is a diagram for describing an advertisement database 1C provided on the management device 1 side, and FIG. 6B is a diagram for describing an advertisement display standby memory 5A provided on the mobile terminal 5 side;

FIG. 7 is a flowchart showing operations of the store terminal 3 which are started when an “advertisement processing” field is selected from the processing menu of the store terminal 3;

FIG. 8 is a flowchart of operations following the operations in FIG. 7;

FIG. 9 is a flowchart showing operations of the management device 1 which are started in response to a request or an instruction from the store terminal 3;

FIG. 10 is a flowchart for describing in detail selection processing (Step B7 in FIG. 9) for selecting delivery-target members which is performed on the management device 1 side;

FIG. 11 is a flowchart of advertisement processing that is started at a regular interval (such as every second) on the mobile terminal 5 side;

FIG. 12A and FIG. 12B are diagrams of a mobile terminal screen on an advertisement recipient side, of which FIG. 12A shows a standby screen where an advertisement notification has not been displayed, and FIG. 12B shows a standby screen where an advertisement notification has been displayed;

FIG. 13A and FIG. 13B are diagrams of specific examples when an advertisement notification is being displayed in detail on the mobile terminal screen on the advertisement recipient side;

FIG. 14 is a block diagram showing the overall structure of an advertisement delivery system that transmits and receives store advertisement data via a communication network;

FIG. 15 is a diagram for describing plural types of delivery methods regarding how store advertisement data is delivered and to which type of advertising media it is delivered;

FIG. 16 is a diagram for describing store customer-management information 3A;

FIG. 17A is a diagram for describing an advertisement database 1C provided on the management device 1 side, and FIG. 17B is a diagram for describing a signage database 1D provided on the management device 1 side;

FIG. 18 is a flowchart showing operations of the store terminal 3 which are started when the “advertisement processing” field is selected from the processing menu of the store terminal 3;

FIG. 19 is a flowchart of operations following the operations in FIG. 18; and

FIG. 20 is a flowchart showing operations of the management device 1 which are started in response to a request or an instruction from the store terminal 3.

### DETAILED DESCRIPTION OF THE PREFERRED EMBODIMENTS

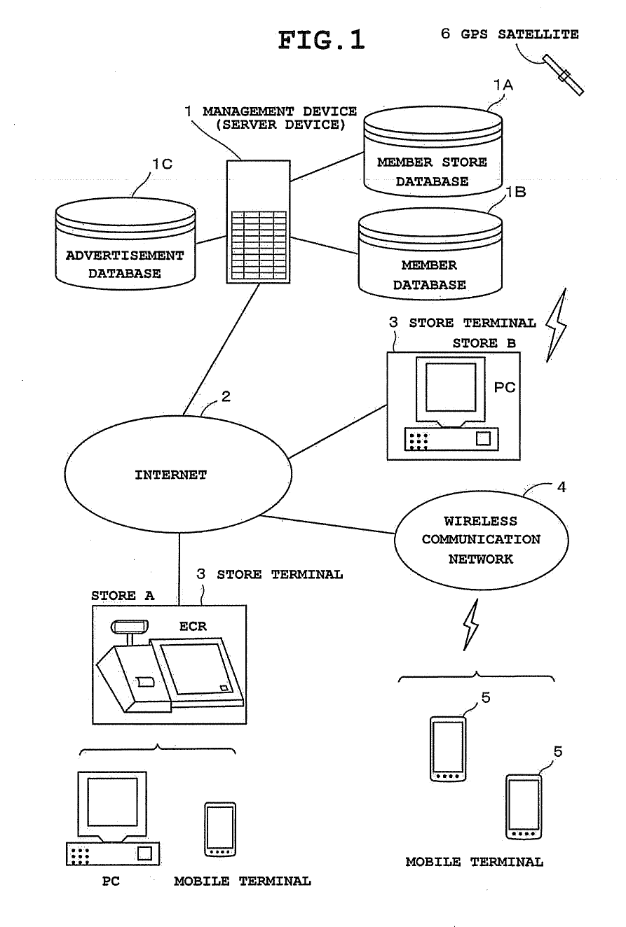

A first embodiment of the present invention will hereinafter be described with reference to FIG. 1 to FIG. 13.

FIG. 1 is a block diagram showing the overall structure of an advertisement delivery system that transmits and receives store advertisement data via a communication network.

This advertisement delivery system is a wide area communication system of a nationwide scale whose core is a management device (server device) 1 on the side of a service provider (operator) that provides an advertisement delivery service by which store advertisement data is transmitted and received via a communication network. The service provider is a service operator that provides various types of services such as local news, weather information and event guides to its members in addition to the advertisement delivery service.

When a store that is a member of the advertisement delivery service (member store) gives an instruction to deliver advertisement data of the store, the management device (server device) 1 simultaneously delivers this store advertisement data to the end users (advertisement recipients) using a push notification method. Note that the end users (advertisement recipient) herein refer to member users of any of the various services operated by the service provider. Also note that, although an example in which the end users are member users is described in the first embodiment, they may be service subscribers including users who have downloaded an advertisement application described hereafter in addition to member users.

The management device 1 is a computer system that performs registration processing for registering each store that has contracted with the service provider (member store) and registering each end user (member user), as well as registering and managing received advertisement data arbitrarily created by each member store, and push-delivering the advertisement data to the member users. This management device 1 is connected to each store terminal 3 via the Internet 2, and also connected to each mobile terminal 5 on the member user side via the Internet 2 and a wireless communication network (mobile communication network) 4.

When performing advertisement notification in which store advertisement data is push-delivered to each mobile terminal 5 of the member users, the management device 1 gives notification including the location information (longitude and latitude information) of the store, and information indicating an advertising distance and an advertising end time described hereafter. Note that the service provider side includes a member store database 1A in which information related to each store (member store) is registered and managed, a member database 1B in which information related to each end user (member user) is registered and managed, an advertisement database 1C described hereafter, etc.

The store terminal 3 is a sales data processing device such as an Electronic Cash Register (ECR) or a Point Of Sale (POS) terminal that registers sales data for each transaction, in which advertisement application software (not shown) has been installed that provides an advertisement creating function for creating arbitrary advertisement data for the store itself, an advertisement delivery instructing function for instructing the management device 1 to push-deliver the created advertisement data to each member user, etc. Here, the advertisement delivery instructing function is a transmitting function for transmitting a delivery instruction for advertisement data to the management device 1 via the Internet 2 in response to an instruction operation giving an instruction to deliver the store advertisement data.

Note that the store terminal 3 is not limited to an ECR terminal or a POS terminal, and may be a Personal Computer (PC) set in the store or a mobile terminal (such as a multi-functional mobile phone referred to as a smart phone) of the person in charge of the store who works inside or outside the store. In addition, the store terminal 3 may differ with each store. In the example in FIG. 1, store “A” uses an ECR as the store terminal 3 and store “B” uses a PC as the store terminal 3. When using a PC or a mobile terminal as the store terminal 3, the store receives the advertisement application software that provides the advertisement creating function, the advertisement delivery instructing function, and the like from the service provider and installs it in the store terminal 3, as in the case of the sales data processing device described above. Also note that, although the advertisement application software has been installed in the case of the first embodiment, a web application, such as cloud computing, may be used in a case where the advertisement application software has not been installed.

The mobile terminal 5 is a mobile terminal of the member user, such as a mobile phone. In the first embodiment, the mobile terminal 5 is a multi-functional mobile phone referred to as a smart phone. When the mobile terminal 5 is connected to the wireless communication network (mobile communication network) 4 from a nearby base station or switchboard (not shown), high speed and high volume communication with other mobile phones (not shown) can be performed via the wireless communication network 4. In addition, when the mobile terminal 5 is connected to the Internet 2 via the wireless communication network 4, websites can be accessed and viewed. In the mobile terminal 5, a Global Positioning System (GPS) function has been installed for acquiring the current position of the mobile terminal 5 using reception radio waves from a GPS satellite 6.

When the mobile terminal 5 receives an advertisement notification (such as advertisement content, store location, advertising end time and advertising distance) from the management device 1 via the Internet 2 and the wireless communication network 4, the mobile terminal 5 acquires the current position of the mobile terminal 5 itself using the GPS satellite 6, and judges whether or not the mobile terminal 5 itself is within the advertising distance from the location of the store, or in other words, whether or not the member user carrying the mobile terminal 5 is near the store. Then, when it is judged that the mobile terminal 5 is within the advertising distance (near the store), for example, message data “advertisement service: 1 new notification” is displayed on the terminal screen, as advertisement reception information indicating that advertisement data has been received.

When a delivery instruction for store advertisement data transmitted from the store terminal 3 via the management device 1 is received, the mobile terminal 5 judges whether or not the distance from the location of the store to the current position is within a predetermined range, and displays the advertisement data on condition that the distance is within the predetermined range. Information (store location and advertising distance) required by the mobile terminal 5 to make this judgment is transmitted from the store terminal 3 and delivered to the management device 1. Note that the advertisement reception information may be an advertisement icon or the like. As described above, the mobile terminal 5 functions as an advertising medium that displays advertisement data, and the display timing of the contents of received advertisement notification is based on a condition that the mobile terminal 5 is within the advertising distance (near the store).

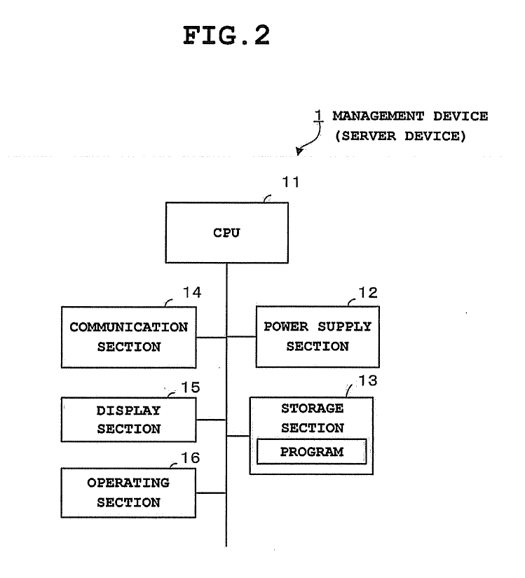

FIG. 2 is a block diagram showing basic components of the management device 1.

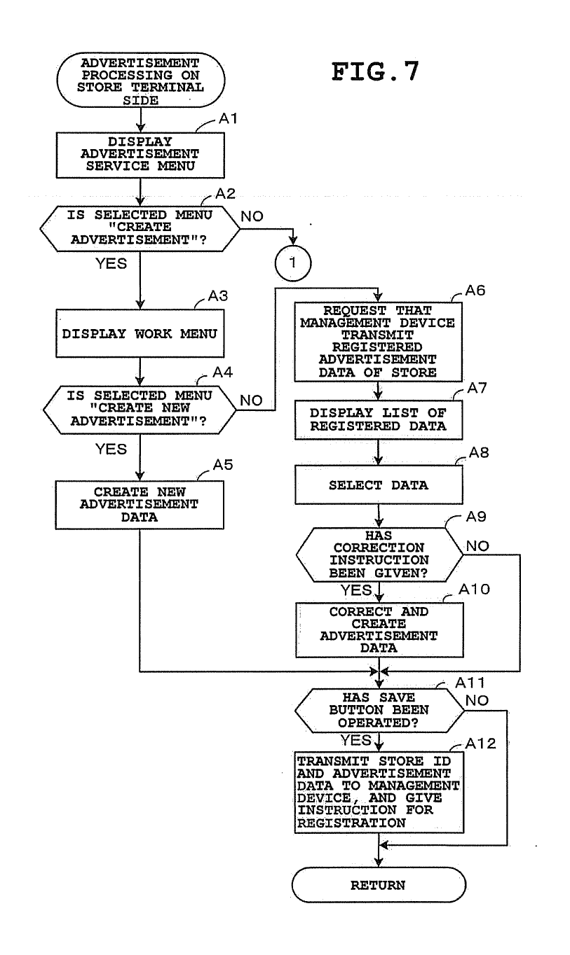

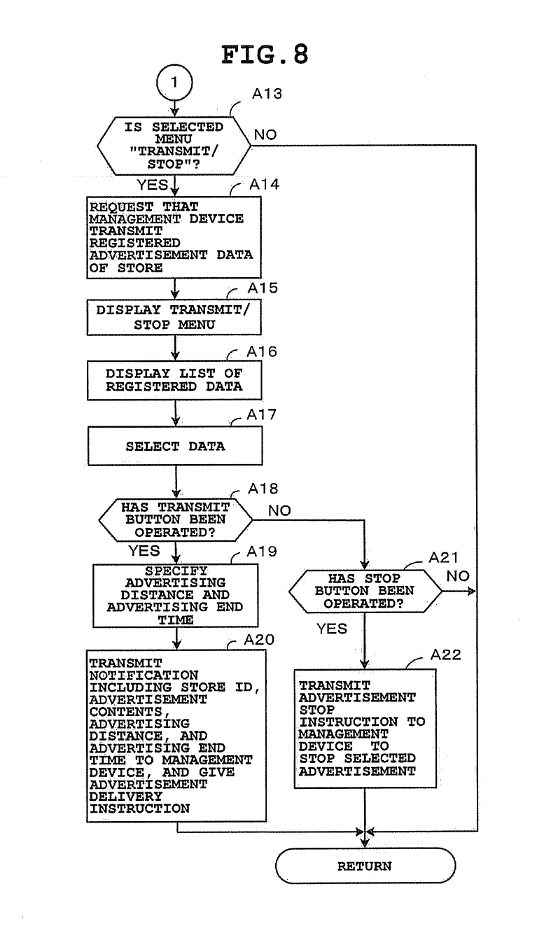

A Central Processing Unit (CPU) 11 in FIG. 2, which serves as the core of the management device 1, operates by receiving power from a power supply section 12 including an uninterruptible power supply (not shown), and controls the entire operations of the management device 1 in accordance with various programs stored in a storage section 13. The storage section 13 stores various programs and information, such as programs and various applications for actualizing the first embodiment based on operation procedures shown in FIG. 7 and FIG. 8, and information required by these programs and applications. This storage section 13 has a work area that temporarily stores various information (such as a current time clocked by a clock function, a flag, and a timer) required to operate the management device 1. Note that the storage section 13 may include a storage area in a predetermined external server.

A communication section 14 in FIG. 2 is a communication interface capable of performing multiple simultaneous access. This communication section 14 is connected to broadband Internet (such as by optical communication connection), and transmits and receives advertisement data and the like to and from the store terminal 3, or transmits and receives data to and from an electronic payment system (not shown). Also, this communication section 14 push-delivers advertisement data to each mobile terminal 5 of the member users. A display section 15 in FIG. 2 displays an operator confirmation screen, a work screen, etc. An operating section 16 in FIG. 2 includes a full keyboard and the like, and the CPU 11 performs processing based on input signals from this operating section 16.

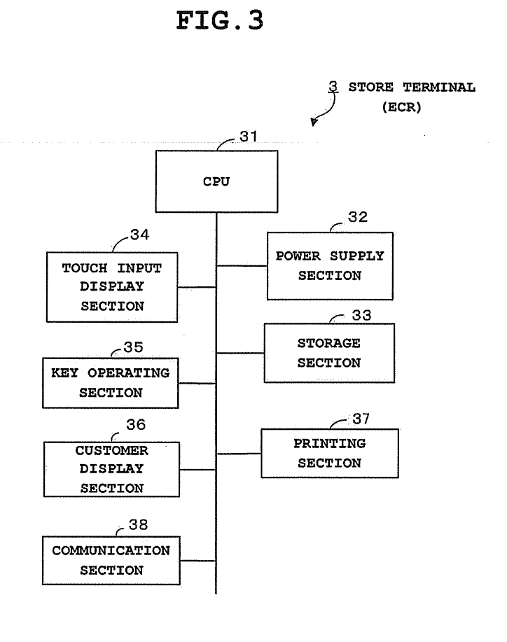

FIG. 3 is a block diagram showing basic components of the store terminal 3.

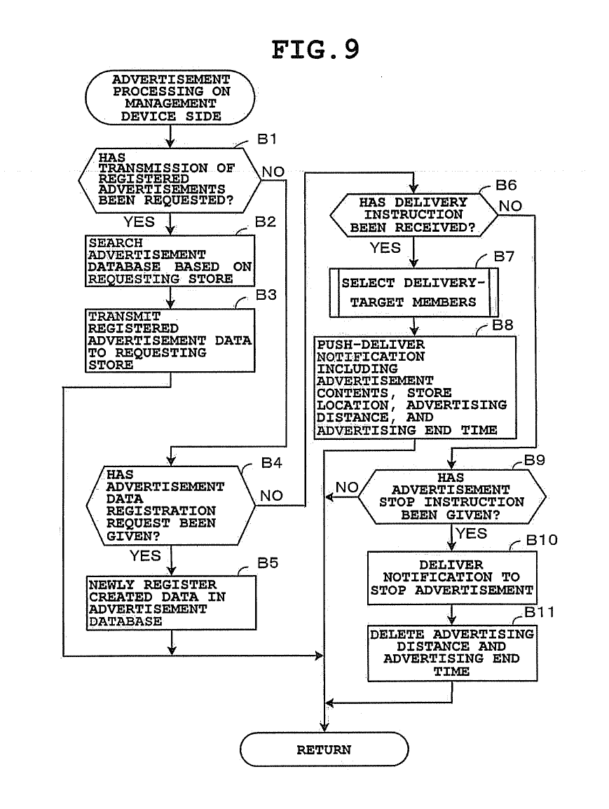

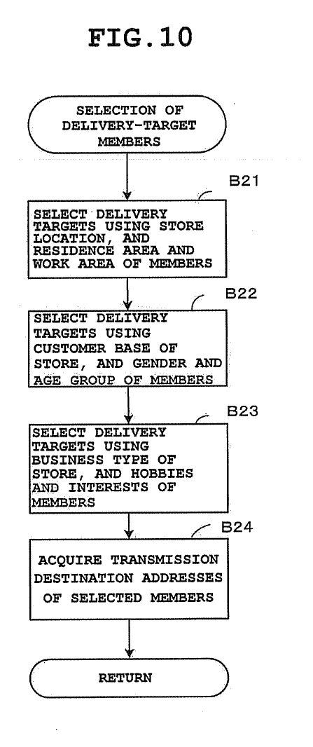

The store terminal 3, which constitutes an ECR in the example in FIG. 3, has the above-described advertisement creating function and the advertisement delivery instructing function in addition to the basic functions (sales data registering function and the like) of the ECR. A CPU 31 serving as the core of the store terminal 3 operates by receiving power supply from a power supply section 32, and controls the entire operations of the store terminal 3 in accordance with various programs stored in a storage section 33. The storage section 33 stores various programs and information, such as programs and various applications for actualizing the first embodiment based on operation procedures shown in FIG. 9 and FIG. 10, and information required by these programs and applications. This storage section 33 has a work area that temporarily stores various information (such as a current time clocked by a clock function, a flag, and a timer) required to operate the store terminal 3.

A touch input display section 34, a key operating section 35, a customer display section 36, a printing section 37, and a communication section 38 in FIG. 3 are connected to the CPU 31 via a bus line, as peripheral input and output devices, and the CPU 31 controls these components in accordance with an input and output program.

The touch input display section 34 includes a display panel and a touch panel (not shown). The touch panel is arranged on the front surface of a high definition display panel, and software keys (touch keys) are allocated and arranged in the touch input display section 34. This touch input display section 34 displays function names, arbitrarily created advertisement data, etc. Also, this touch input display section 34 senses a touch operation performed by a finger or the like, and inputs data based on the touch operation. Note that, among various methods such as a capacitance method, a resistive-film method, an electromagnetic-induction method and a piezoelectric method, the capacitance method having excellent lightweightness, light transmission, durability and the like is used in the touch panel of this embodiment. However, other methods may also be used. The key operating section 35 has various push-button keys (such as a power key). The customer display section 36 displays product prices, subtotals and the like which have been registered as sales. The printing section 37 prints out receipts. The communication section 38 is a communication interface that transmits and receives advertisement data and the like to and from the management device 1 via the Internet 2.

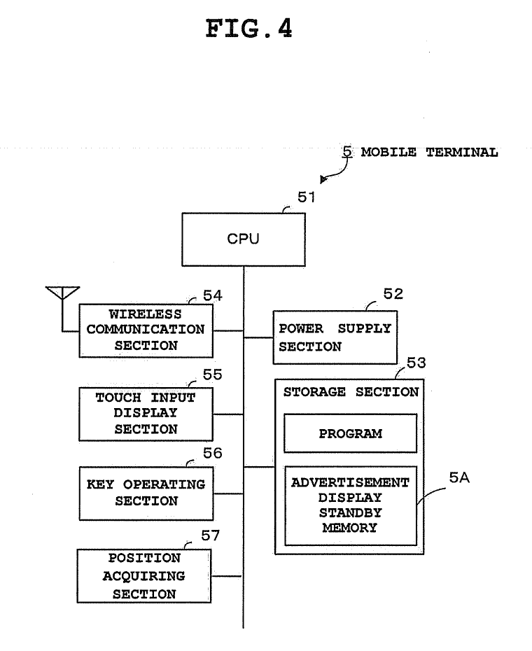

FIG. 4 is a block diagram showing basic components of the mobile terminal 5.

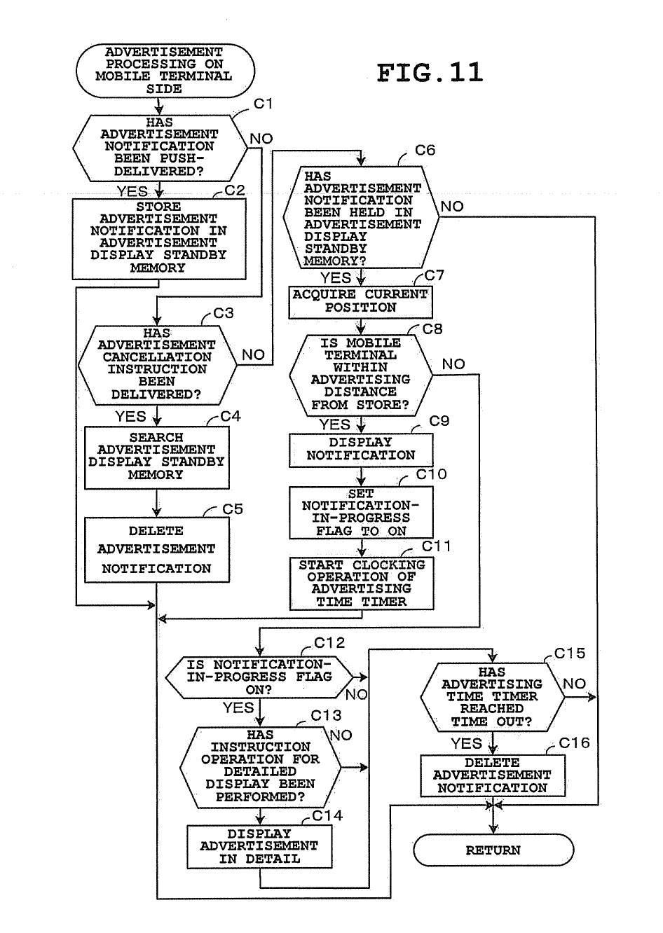

The mobile terminal 5 provides a cell function, an electronic mail function, an internet connection function, a GPS function, and the like. A CPU 51 serving as the core of the mobile terminal 5 operates by receiving power from a power supply section 52 including a secondary battery (not shown), and controls the entire operations of the mobile terminal 5 in accordance with various programs stored in a storage section 53. The storage section 53 stores various programs and information, such as programs and various applications for actualizing the first embodiment based on operation procedures shown in FIG. 11 and information required by these programs and applications. This storage section 53 has a work area that temporarily stores various information (such as a current time clocked by a clock function, a flag and a timer) required to operate the mobile terminal 5. An advertisement display standby memory 5A in the storage section 53 is to receive and successively store advertisement notifications push-delivered from the management device 1. The CPU 51 displays notification contents stored in this advertisement display standby memory 5A on a condition that the above-described display timing has been reached.

A wireless communication section 54, a touch input display section 55, a key operating section 56, and a position acquiring section 57 in FIG. 4 are connected to the CPU 51 as peripheral input and output devices. The wireless communication section 54 transmits and receives data to and from a nearby base station during the operation of the cell function, the electronic mail function, the internet connection function or the like. The touch input display section 55 includes a display panel and a touch panel in which the touch panel is arranged on the front surface of a high definition display panel. The key operating section 56 has various push-button keys (such as a power key). The position acquiring section 57 provides the GPS function, and thereby receives and acquires a current position.

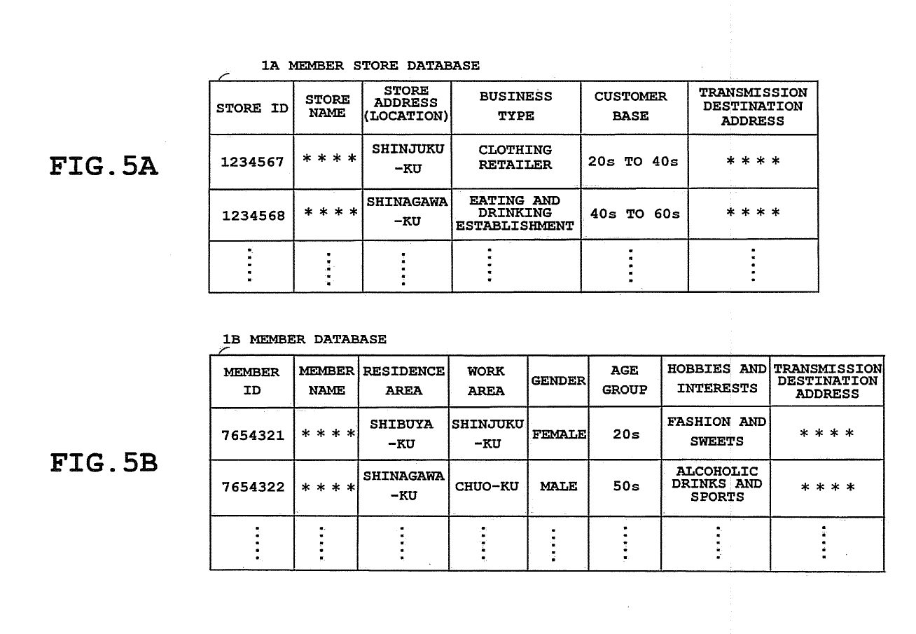

FIG. 5A is a diagram for describing the member store database 1A provided on the management device 1 side.

The member store database 1A, which is used to register and manage information related to each member store, has a “store ID” field, a “store name” field, a “store address (location)” field, a “business type” field, a “customer base” field, a “transmission destination address” field and the like. In the example in FIG. 5A, a store is shown whose “store ID” is “1234567” “store address (location)” is “Shinjuku-ku”, “business type” is “clothing retailer”, and “customer base” is “20s to 40s”. In addition, a store is shown whose “store ID” is “1234568”, “store address (location)” is “Shinagawa-ku”, “business type” is “eating and drinking establishment”, and “customer base” is “40s to 50s”.

FIG. 5B is a diagram for describing the member database 1B provided on the management device 1 side.

The member database 1B, which is used to register and manage information related to member users, has a “member ID” field, a “member name” field, a “residence area” field, a “work area” field, a “gender” field, an “age group” field, a “hobbies and interests” field, a “transmission destination address” field and the like. In the example in FIG. 5B, a member is shown whose “member ID” is “7654321”, “residence area” is “Shibuya-ku”, “work area” is “Shinjuku-ku”, “gender” is “female”, “age group” is “20s”, and “hobbies and interests” is “fashion and sweets”. In addition, a member is shown whose “store ID” is “765432”, “residence area” is “Shinagawa-ku”, “work area” is “Chuo-ku”, “gender” is “male”, “age group” is “50s”, and “hobbies and interests” is “alcoholic drinks and sports”.

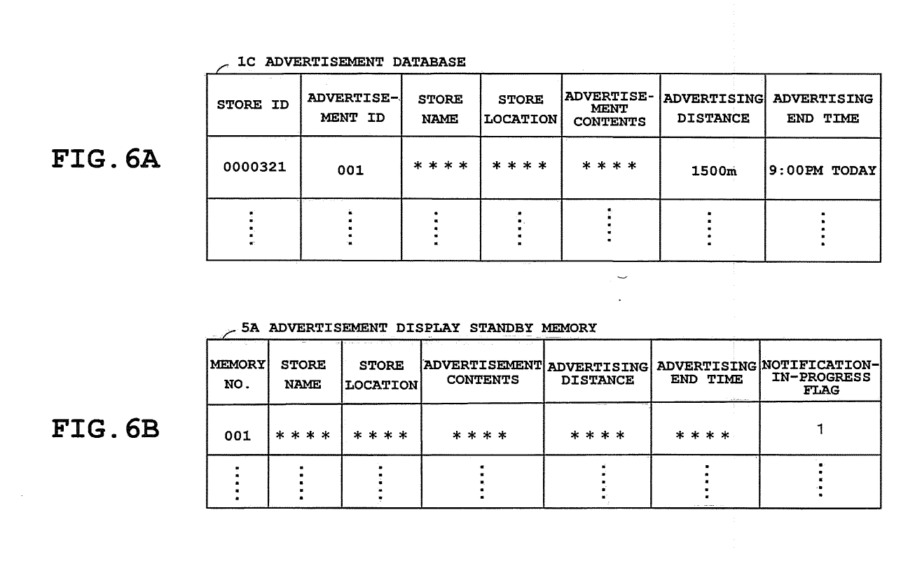

FIG. 6A is a diagram for describing the advertisement database 1C provided on the management device 1 side.

The advertisement database 1C, which is used to register and manage advertisement data for which a delivery instruction has been given by the store terminal 3, includes a “store ID” field, a “store name” field, a “store location” field, an “advertisement ID” field, an “advertisement contents” field, an “advertising distance” field, an “advertising end time” field and the like. The “store ID” and the “store name” are information used to identify a member store and the “store location” is longitude and latitude information indicating the location of the store. The “advertisement ID” is information used to identify a plurality of advertisement data for which delivery requests have been made from the same store.

The “advertisement contents” indicates advertisement data created on the store terminal 3 side, which may include a diagram or an image with text, or may be created having a handwritten appearance. The “advertising distance” is information indicating an advertising target area (advertising range) arbitrarily specified on the store terminal 3 side. Specifically, this information indicates the radius of the advertising range in meters centering on the “store location”.

Note that, in the first embodiment, the “advertising distance” can be arbitrarily specified within a range of 500 m to 2000 m. In the example in FIG. 6A, “1500 m” has been specified. The “advertising end time” refers to the ending time of advertisement specified on the store terminal 3 side. In the example in FIG. 6A, “9:00 pm today” has been registered. Note that this “advertising end time” is not limited to time, and may be “advertising end date” including a date or a day of the week.

FIG. 6B is a diagram for describing the advertisement display standby memory 5A provided on the mobile terminal 5 side.

The advertisement display standby memory 5A, which sequentially stores the advertisement notifications of respective stores which have been push-delivered from the management device 1, includes a “memory No.” field, a “store name” field, a “store location” field, an “advertisement contents” field, an “advertising distance” field, an “advertising end time” field and a “notification-in-progress flag” field. The “memory No.” is a serial number starting from 001, and the value of which indicates the number of advertisement notifications stored and held in the advertisement display standby memory 5A. The “notification-in-progress flag” indicates a state where an advertisement notification is being displayed on the touch input display section 55 that is the terminal screen. When the flag is “1”, notification is in progress (advertisement notification is being displayed). Note that, when an instruction to stop advertising is given by the store terminal 3 or when the “advertising end time” is exceeded, the corresponding advertisement notification in the advertisement display standby memory 5A is deleted. The “store location” is information (longitude and latitude information) indicating the location of a store.

Next, the operational concept of the advertisement system according to the first embodiment will be described with reference to the flowcharts shown in FIG. 7 to FIG. 11. Here, each function described in the flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. Note that FIG. 7 and FIG. 8 are flowcharts outlining operations of the characteristic portion of the first embodiment from among all of the operations of the store terminal 3. After exiting the flows in FIG. 7 and FIG. 8, the procedure returns to the main flow (not shown) of the overall operation.

These flowcharts in FIG. 7 and FIG. 8 show operations of the store terminal 3 that are started when an “advertisement processing” field is selected from the processing menu of the store terminal 3.

First, the CPU 31 of the store terminal 3 displays an advertisement service menu on the touch input display section 34 (Step A1 in FIG. 7). This advertisement service menu is a menu screen including a “create advertisement” field for requesting the creation of advertisement data and a “transmit/stop” field for requesting the transmission of advertisement data or the cancellation of advertisement during advertising. Then, when the “create advertisement” field is selected from the menu screen by a user operation (YES at Step A2), the CPU 31 switches the menu to display a work menu (Step A3). This work menu is a menu screen including a “create new advertisement” field for requesting the creation of new advertisement data and a “use past advertisement” field for requesting the use of advertisement data created in the past.

When the “create new advertisement data” field is selected from the work menu by a user operation (YES at Step A4), the CPU 31 proceeds to new advertisement data creation processing (Step A5). In the new advertisement data creation processing, the user creates advertisement data by inputting text, symbols, diagrams and the like, using an advertisement material (such as a diagram, text or an image) arbitrarily selected from advertisement materials prepared in advance, or various software keys (touch keys) allocated and displayed on the touch input display section 34, or by performing handwriting input on the touch input display section 34 to create advertisement data including a handwritten image. The created advertisement data can be colored or modified. Note that the advertisement data may be created using business type-specific templates or a wizard format.

Conversely, when the “use past advertisement” field is selected from the work menu screen by a user operation (NO at Step A4), the CPU 31 performs processing to request the transmission of the registered advertisement data of the user's own store (Step A6). When the registered advertisement data transmitted from the management device 1 in response to the request is received, the CPU 31 displays the advertisement data in a list (Step A7). This advertisement list screen displays (such as by thumbnail display) a list of various advertisement data registered in advance on the management device 1 side for use by the store. Then, when desired advertisement data is selected from the list screen by a user operation (Step A8), the CPU 31 judges whether or not an instruction to correct this advertisement data has been given (Step A9). Here, when the selected advertisement data is data whose contents can be used every day, such as “Today's Time-Limited Sale: Beer Half Off from 5:00 pm to 6:00 pm!”, correction is not required and therefore a correction instruction is not given. However, when a correction instruction is given to change the service contents, time or the like (YES at Step A9), the CPU 31 proceeds to edit processing and creates desired advertisement data by correcting and editing the selected data (Step A10).

When new advertisement data is created (Step A5) or the selected advertisement data is corrected (Step A10) as described above, or when an instruction is given to reuse the selected advertisement data as it is, the CPU 31 proceeds to subsequent Step A11, and judges whether or not the save button (not shown) of the work menu has been operated. When judged that the save button has not been operated (NO at Step A11), the CPU 31 exits the flow in FIG. 7 and FIG. 8 to invalidate the currently created or selected data. When judged that the save button has been operated (YES at Step A11), the CPU 31 performs processing for transmitting the store ID and the advertisement data to the management device 1 and requesting the registration thereof (Step A12), and exits the flows in FIG. 7 and FIG. 8.

At Step A2, when the “create advertisement” field is not selected from the above-described advertisement service menu (NO at Step A2), the CPU 31 proceeds to the flow in FIG. 8 and judges whether or not the “transmit/stop” field has been selected. When judged that the return button (not shown) of the advertisement service menu has been operated, the CPU 31 exits the flows in FIG. 7 and FIG. 8. When judged that the “transmit/stop” field has been selected (YES at Step A13), the CPU 31 performs processing to request the transmission of the registered advertisement data of the user's own store (Step A14). Then, when the registered advertisement data is received from the management device 1 in response to the request, the CPU 31 displays a transmit/stop menu (Step A15). This transmit/stop menu is a menu screen including a transmit button for giving an instruction to deliver advertisement data and a stop button for giving an instruction to stop the outputting of advertisement data. Then, the CPU 31 displays a list of the received registered advertisement data of the user's own store in the transmit/stop menu (Step A16).

Subsequently, when advertisement data desired by the user is selected from this advertisement list screen in the transmit/stop menu (Step A17), the CPU 31 judges whether or not the transmit button has been operated (Step A18) and whether or not the stop button has been operated (Step A21). When judged that the transmit button has been operated (YES at Step A18), the CPU 31 waits for the user to specify an “advertising distance” and an “advertising end time” for the advertisement (Step A19). On the store side, after determining a distance from the store which serves as the advertising range, based on the status of the store, contents to be advertised, etc., and determining the duration of the advertisement, the user specifies and inputs an “advertising distance” and an “advertising end time” determined thereby using the touch input display section 34. Then, the CPU 31 creates a notification including the advertisement contents of the arbitrarily selected advertisement data, and the arbitrarily specified advertising distance and advertising end time, and transmits it to the management device 1 as a delivery instruction instructing the mobile terminal 5 to deliver the advertisement (Step A20). At Step A21, when judged that the stop button has been operated (YES at Step A21), the CPU 31 transmits to the management device 1 a stop instruction instructing the mobile terminal 5 to stop the delivery (Step A22).

FIG. 9 is a flowchart showing operations of the management device 1 which are started in response to a request or an instruction from the store terminal 3. After exiting the flow in FIG. 9, the procedure returns to the main flow (not shown) of the overall, operation.

First, when a request or an instruction from the store terminal 3 is received, the management device 1 judges whether or not the transmission of the advertisement data of the requesting store has been requested (Step 131). When judged that the transmission of the advertisement data has been requested (YES at Step B1), the CPU 11 searches the advertisement database 1C based on the requesting store (store ID) (Step B2), and after reading out all advertisement data registered in association with the store, transmits the advertisement data to the requesting store terminal 3 (Step B3). Note that, in a case where the owner is operating a plurality of stores, such as chain stores, advertisement data registered in association with the plurality of stores may be read out and transmitted.

Also, when the registration of advertisement data created by the store terminal 3 is requested (YES at Step B4), the CPU 11 registers the “store ID”, the “store name”, and the “store location” based on the requesting store, and after registering the created data as “advertisement contents”, registers a new “advertisement ID” by updating the “advertisement ID” of the store (Step B5). Also, when a delivery instruction for advertisement data is received from the store terminal 3 (YES at Step B6), the CPU 11 performs selection processing for selecting delivery-target members described hereafter, (Step B7) and push-delivers a notification including the advertisement contents, the store location, the advertising distance, and the advertising end time to the mobile terminal of each delivery-target member (Step B8). Also, when an advertisement stop instruction is received from the store terminal 3 (YES at Step B9), the CPU 11 push-delivers to the mobile terminal 5 of each delivery-target member a notification giving an instruction' to stop the advertisement (Step B10). Then, the CPU 11 deletes the “advertising distance” and the “advertising end time” of the advertisement for which the notification for advertisement stop has been delivered, from the advertisement database 1C (Step B11), and exits the flow in FIG. 9.

FIG. 10 is a flowchart for describing in detail the selection processing (Step B7 in FIG. 9) for selecting delivery-target members which is performed on the management device 1 side.

First, the management device 1 selects delivery-target members based on the store location, and the residence area and the work area of the members (Step B21). That is, the management device 1 searches the member store database 1A based on the store that has given the delivery instruction, and acquires the “store location” of the store. Then, the management device 1 identifies the delivery-target area based on the “store location”, and sets members whose “residence area” or “work area” corresponds to the identified area as delivery targets. Specifically, the management device 1 identifies the area including the district, city or town of the “store location” and surrounding areas centering thereon, and after searching the member database 1B based on the identified area, sets members whose “residence area” or “work area” corresponds to the identified area as delivery targets.

For example, in cases where the “store location” is “Shinjuku-ku”, Shinjuku-ku, Shibuya-ku, Nakano-ku, Bunkyo-ku, Toshima-ku, Minato-ku, and Chiyoda-ku constitute the delivery-target area. However, the method for deciding a delivery-target area is not limited thereto, and the delivery-target area may be, for example, within 10 km of the “store location”. Also, the “residence area” or the “work area” or both may be used as the delivery-target area depending on the day of the week on which the advertising is performed or whether or not the day is a holiday. In this way, the selection of delivery targets is performed using the area determined with reference to the “store location”. In the first embodiment, the selection of delivery targets based on the store attributes and the member attributes is further performed with reference to the member store database 1A and the member database 1B.

That is, the management device 1 selects members matching the “customer base” of the store as delivery-targets, using the “customer base” of the store and the “gender” and the “age group” of the members (Step B22). For example, in a case where the “customer base” of the store is “women in their 20s to 40s”, the corresponding female members are selected. Next, the management device 1 selects members matching the “business type” of the store using the “business type” of the store and the “hobbies and interests” of the corresponding female members (Step B23). For example, when the “business type” of the store is “women's clothing retailer”, female members interested in fashion are selected. Subsequently, the management device 1 reads out and acquires the “transmission destination address” of the selected members from the member database 1B (Step B24). Then, the notification including the advertisement contents, the store location, the advertising distance, and the advertising end time is push-delivered to the mobile terminal 5 of each selected delivery-target member, as described in Step B8 of FIG. 9.

FIG. 11 is a flowchart of advertisement processing that is started at a regular interval (such as every second) on the mobile terminal 5 side. After exiting the flow in FIG. 11, the procedure returns to the main flow (not shown) of the overall operation.

First, the CPU 51 of the mobile terminal 5 judges whether or not an advertisement notification push-delivered by the management device 1 has been received (Step C1). When judged that an advertisement notification has been received (YES at Step C1), the CPU 51 performs processing to store and hold the advertisement notification in the advertisement display standby memory 5A (Step C2), and exits the flow in FIG. 11. Also, when judged that an instruction for advertisement cancellation has been received from the management device 1 (YES at Step C3), the CPU 51 searches the advertisement display standby memory 5A for the advertisement notification for which the cancellation instruction has been received (Step C4), and after performing processing to delete the notification from the advertisement display standby memory 5A (Step C5), exits the flow in FIG. 11.

On the other hand, when judged that an advertisement notification or an advertisement cancellation instruction has not been received (NO at Step C3), the CPU 51 judges whether or not an advertisement notification has been stored and held in the advertisement display standby memory 5A (Step C6). When judged that an advertisement notification has not been held (NO at Step C6), the CPU 51 exits the flow in FIG. 11. Conversely, when judged that an advertisement notification has been stored and held (YES at Step C6), the CPU 51 receives and acquires the current position from the position acquiring section 57 providing the GPS function (Step C7), and judges whether or not the mobile terminal 5 is within the advertising distance from the store, or in other words, near the store based on the “store location” and the “advertising distance” indicated in the advertisement notification (Step C8).

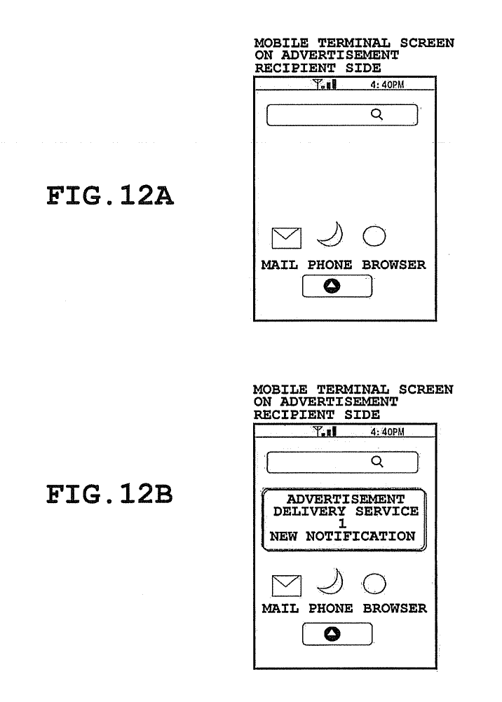

When judged that the mobile terminal 5 is far away from the store and not within the advertising distance (NO at Step C8), the CPU 51 proceeds to Step C12 described hereafter. Conversely, when judged that the mobile terminal 5 is within the advertising distance from the store (YES at Step C8), the CPU 51 displays, on the touch input display section 55, information indicating that the advertisement notification has been received (information indicating that a new advertisement notification has been received and the number of advertisement notifications) (Step C9). FIG. 12A shows the mobile terminal screen on the advertisement recipient side (member user side) in which a standby screen where an advertisement notification has not been displayed is shown: FIG. 12B also shows the mobile terminal screen on the advertisement recipient side, in which a standby screen displaying an advertisement notification is shown. In this instance, the information indicating the reception of a new advertisement notification and the number of advertisement notifications (one new advertisement notification in the example in FIG. 12B) are displayed in the center portion of the standby screen following the display of “advertisement delivery service”.

Then, the CPU 51 sets a “notification-in-progress” flag corresponding to the notification in the advertisement display standby memory 5A to ON so as to indicate that the advertisement notification is being displayed (Step C10). Next, the CPU 51 calculates the amount of time from the current time to the advertising end time, and after setting an advertising time timer (not shown) to the calculated time, starts a clocking operation (Step C11). For example, when the “advertising end time” is “9:00 pm” and the current time is “5:30 pm”, the advertising time timer is set to “3 hours and 30 minutes”, from 5:30 pm to 9:00 pm. Then, after the clocking operation of the timer is started for each advertisement notification, the CPU 51 exits the flow in FIG. 11. Note that the advertising time timer is a counter that subtracts elapsed time from a set value.

Then, the CPU 51 judges whether or not a notification whose notification-in-progress flag has been set to ON is present (Step C12), and judges whether or not any advertising time timer has reached time out (Step C15). When judged that a notification whose notification-in-progress flag has been set to ON is present (YES at Step C12), the CPU 51 judges whether or not an instruction operation giving an instruction to display the notification contents in detail has been performed (Step C13). When judged that an operation to touch the display area of the advertisement notification on the standby screen has been performed as an operation for giving an instruction to display the notification contents in detail (YES at Step C13), the CPU 51 reads out the “store name” and the “advertisement contents” of the notification and displays the “store name” and the “advertisement content” in detail on the touch input display section 55 (Step C14).

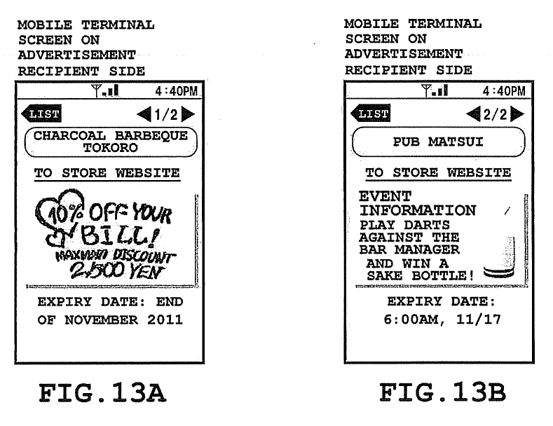

FIG. 13A and FIG. 13B are diagrams of specific examples when an advertisement notification is being displayed in detail on the mobile terminal screen on the advertisement recipient side.

FIG. 13A shows an example in which “advertisement contents” have a handwritten appearance and include a uniform resource locator (URL) for accessing the website of the store, the expiry date of a service, etc. FIG. 13B shows an example in which “advertisement contents” are text including an image and includes a URL for accessing the website of the store, the expiry date of a service, etc. The “list” in FIG. 13A and FIG. 13B indicates a list button for proceeding to the list screen of advertisement notifications, and the “½” and “ 2/2” indicate the currently displayed page in relation to the total number of pages. The triangle marks placed on the sides of the “½” and “ 2/2” of the displayed page indicate page turning buttons in the forward and back directions.

On the other hand, when judged that a notification whose notification-in-progress flag has been set to ON is not present (NO at Step C12), or that a notification whose notification-in-progress flag has been set to ON is present but an instruction to display in detail has not been given (NO at Step C13), or when the detailed display has been completed (Step C14), the CPU 51 judges whether or not the advertising time timer has reached time out (Step C15). When judged that a notification that has reached time out is present (YES at Step C15), the CPU 51 deletes the notification from the advertisement display standby memory 5A (Step C16) and exits the flow in FIG. 11.

As described above, in the first embodiment, the store terminal 3 constituting the advertisement delivery service transmits a delivery instruction for advertisement data to the management device 1 in response to an instruction operation giving an instruction to deliver the advertisement data, and the management device 1 push-delivers the advertisement data of the instructing store to the mobile terminal 5 in response to the delivery instruction transmitted from the store terminal 3. When the advertisement data of the instructing store push-delivered by the management device 1 is received, the mobile terminal 5 outputs the advertisement data on a condition that the distance from the instructing store to the current position of the mobile terminal 5 is within a predetermined range. Therefore, an advertisement having a high customer attraction effect can be transmitted at an appropriate timing based on the status of the store.

That is, timely advertisement can be freely made at anytime based on the current status of the store, such as the store having few customers, the store having received a large stock of products, the store having poor sales, an event being held in the neighborhood, a competitor store being crowded, pedestrian traffic suddenly increasing, rain and the like. In addition, advertising can be performed targeting potential customers near the store, or in other words, potential customers who can be immediately attracted. Accordingly, a high customer attraction effect can be acquired. In this instance, the creation, selection and transmission of advertisement data on the store side, the database processing and push delivery of the advertisement data on the service provider side, and the reception of the advertisement data and judgment regarding the display thereof on the end user side are all performed using digital data. Therefore, unlike conventional advertising media using paper such as flyers and posters, advertisements from a store that has requested an advertisement service can be transmitted to the end users in a short amount of time that is close to real-time.

Also, since advertisements are delivered to only member users who are near the store, unnecessary notifications and annoying notifications to member users in locations other than those near the store can be avoided. In addition, since advertisements are delivered from a plurality of member stores of the advertisement delivery service, there is a benefit to the member users in that they can receive sale information from many stores, unlike the membership of one store. Note that a configuration may be adopted where users who have downloaded the advertisement application are included as the service subscribers in addition to the member users. Since advertisements are transmitted to the subscribers of the advertisement delivery service regardless of whether or not they have the membership of the store, this configuration gives benefit to the member stores in that they can give notifications to a greater number of end users.

Moreover, in the first embodiment, the store terminal 3 has an advertisement data creating function, and transmits advertisement data created by the creating function to the management device 1, together with a delivery instruction. Therefore, advertisement data having appropriate contents can be immediately created based on the status of the store. For example, when an event is being held near the store, the store can create advertisement data corresponding to the event contents, whereby the customer attraction effect is enhanced.

Furthermore, in the first embodiment, the management device 1 receives and registers advertisement data created by the store terminal 3, and transmits the store advertisement data in response to a request from the store terminal 3. Therefore, the store can reuse the created advertisement data as is, or can use the created advertisement data by correcting or editing a portion thereof, which effectively makes the creating operation easier and faster.

Still further, when displaying advertisement data on a condition that the distance from the store to the current position is within a predetermined range, the mobile terminal 5 judges whether or not the distance is within the predetermined range based on the position information of the store delivered from the management device 1 and the current position. Therefore, judgment regarding proximity to a member store can be made on the mobile terminal 5 side.

Yet still further, the store terminal 3 transmits an advertising end time to the management device 1 together with a delivery instruction for the advertisement data. Then, the mobile terminal 5 judges whether or not the end of the advertisement has reached based on the advertising end time and the current time, and displays the advertisement data on a condition that the end of the advertisement has not been reached. As a result of this configuration, only currently valid advertisements can be displayed, which is advantageous for limited-time sale advertisements and the like. Note that the display of the advertisement data is deleted when the advertising end time is reached.

Yet still further, the store terminal 3 transmits a stop instruction for stopping advertisement, and the mobile terminal 5 stops the outputting of the advertisement data of the instructing store in response to the stop instruction from the store terminal 3. As a result of this configuration, advertisement can be freely stopped at any time based on the current status of the store, such as the store having many customers, the store having a low stock of products, a nearby event ending, etc, which is effective in advertisement for a limited number of products, etc.

Yet still further, when delivering store advertisement data to the mobile terminal 5, the management device 1 specifies delivery targets based on the position information of the store and the residence areas or the work areas of the member users, and delivers the advertisement data to the mobile terminals 5 of the delivery targets. As a result of this configuration, an area centering on a store intending to advertise can be specified as a delivery range, and notification to member users who are not potential customers can be avoided.

Yet still further, when delivering store advertisement data to the mobile terminal 5, the management device 1 specifies delivery targets based on the attributes of the store and the attributes of the member users, and delivers the advertisement data to the mobile terminals 5 of the delivery targets. As a result, member users matching the business type and the customer base of the store can be attracted, which leads to a sales increase.

Yet still further, the store terminal 3 transmits to the management device 1 a delivery instruction that gives an instruction to push-deliver advertisement data to the mobile terminal 5 in response to an instruction operation giving an instruction to deliver advertisement data. Also, the store terminal 3 transmits to the management device 1 a delivery instruction giving an instruction to deliver information (store location and advertising distance) required for distance judgment to the mobile terminal 5 that outputs advertisement data on a condition that the distance from the store to the current position is within a predetermined range. Therefore, an advertising range can be determined based on the status of the surroundings of a store intending to advertise, such as an event being held near the store and an instruction to perform advertising can be given within the advertising range.

Yet still further, the store terminal 3 creates store advertisement data and gives an instruction to deliver the advertisement data. As a result of this configuration, by an advertisement whose contents match the status of the store being created and an instruction to deliver this advertisement being given, advertisement that matches the current status of the store can be made.

Yet still further, the store terminal 3 can give an instruction to stop advertisement. Therefore, advertisement can be freely stopped at any time depending on the status of the store, such as the store having many customers by the advertising effect, the store having a low stock of products, a nearby event ending and the like by which advertisement that reflects the intentions of the store can be made.

Note that, although the advertising distance in the first embodiment is specified by the store terminal 3, a fixed advertising distance may be determined on the management device 1 side. In addition, although the advertising distance is a range centering on a store location, an area including an entertainment district nearest to the store, nearby train and bus stations, colleges, event venues, and the like may be the advertising range. Alternatively, the distance from the store to the user of the mobile terminal 5 may be considered within the predetermined range (nearby range).

In addition, although the management device 1 identifies delivery targets by a fixed method based on the residence areas or the work areas of the users of the mobile terminal 5, using the store location. However, the method of identifying delivery targets may be arbitrarily decided. For example, the method of identifying delivery targets can be changed depending on the size of the store. Alternatively, the method of identifying delivery target can be changed in response to an instruction from the store terminal 3.

Moreover, when the mobile terminal 5 is detected to be within an advertising distance in the first embodiment, the display of the advertisement notification is continued even after the mobile terminal 5 moves out of the advertising distance. However, a configuration may be adopted in which, every time the mobile terminal 5 moves out of an advertising distance, the notification display is deleted. In this configuration, even when the mobile terminal 5 moves back and forth into and out of an advertising distance, the notification display can be performed and deleted correspondingly.

Furthermore, in the first embodiment, an advertisement notification is displayed on a condition that the mobile terminal 5 is within the advertising distance. However, the advertisement notification may be displayed when the mobile terminal 5 is within the advertising distance and the advertising start time is drawing near (such as 30 minutes before start). In this configuration, the store side specifies the advertising start time and the advertising end time for each advertisement data, and transmits the advertising start time and the advertising end time to the management device 1.

Still further, in the first embodiment, advertisement data is created on the store side. However, a configuration may be adopted in which the store side can make a request for the creation of advertisement data to the service provider side, in addition to creating advertisement data on its own side.

Yet still further, the store terminal 3 is not limited to an ECR terminal or a POS terminal, and may be a PC, a mobile phone, or the like. In addition, the mobile terminal 5 on the member user side is not limited to a smart phone, and may be a digital camera (compact camera), a Personal Digital Assistant (PDA), a portable music player, a portable gaming device or the like.

Yet still further, the “devices” or the “sections” described in the first embodiment are not required to be in a single housing and may be separated into a plurality of housings by function. In addition, the steps in the above-described flowcharts are not required to be processed in time-series, and may be processed in parallel, or individually and independently.

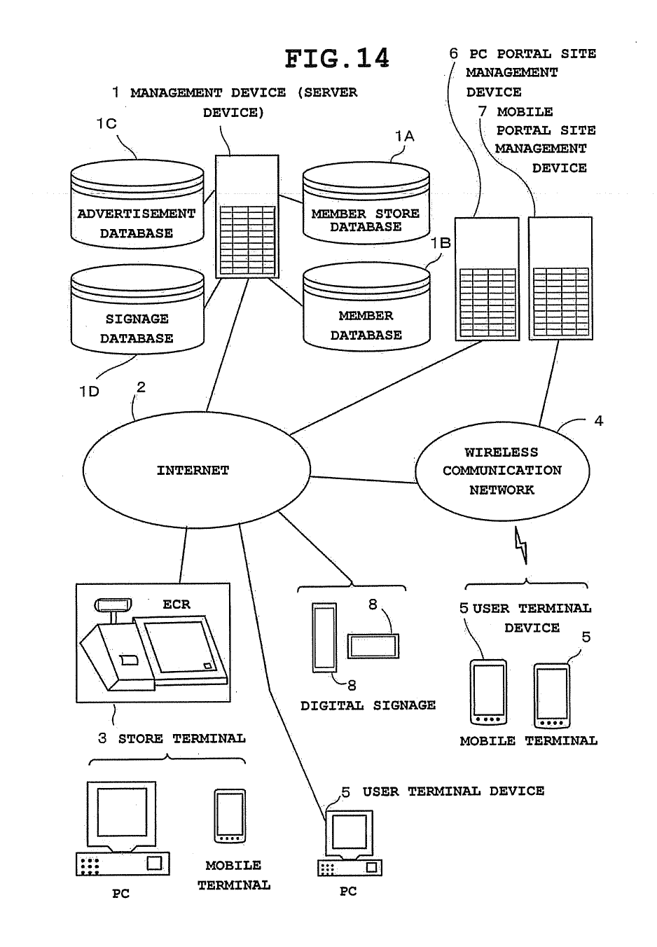

A second embodiment of the present invention will hereinafter be described with reference to FIG. 14 to FIG. 20.

FIG. 14 is a block diagram showing the overall structure of an advertisement delivery system that transmits and receives store advertisement data via a communication network. This advertisement delivery system is a wide area communication system of a nationwide scale whose core is a management device (server device) 1 on the side of a service provider (operator) that provides an advertisement delivery service by which store advertisement data is transmitted and received via a communication network. The service provider is a service operator that provides various types of services such as local news, weather information, and event guides to its members, in addition to the advertisement delivery service.

The service provider side is provided with a member store database 1A that is used to register and manage the locations of stores (store location) and the like as information related to each store (member store), a member database 1B that is used to register and manage positional information such as the residence areas and the work areas of members and the like as information related to each end user (such as a member user), an advertisement database 1C, a signage database 1D that is used to register and manage information related to digital signage (electronic signs) described hereafter, etc. Note that, although an example in which the end users are member users is described in the second embodiment, they may be service subscribers including users who have downloaded an advertisement application described hereafter in addition to member users.

When a store that is a member of the advertisement delivery service (member store) gives an instruction to deliver advertisement data of the store, the management device (server device) 1 delivers the store advertisement data to a predetermined advertising medium in response to this delivery instruction. Note that the advertising medium herein refers to a mobile terminal, digital signage, electronic mail (such as a mail magazine), or a portal site, but is not limited thereto. The management device 1 is a computer system that performs registration processing for registering each store (member store) that has contracted with the service provider and registering each end user (member user), as well as registering and managing received advertisement data arbitrarily created by each member store, and delivering the advertisement data to the advertising medium.

This management device 1 is connected to each store terminal 3 via the Internet 2, and also connected to a user terminal device 5 via the Internet 2 and the wireless communication network (mobile communication network) 4. In addition, the management device 1 is connected to a PC portal site management device 6 supporting PCs via the Internet 2, and also connected to a mobile portal site management device 7 supporting mobile terminals via the Internet 2 and the wireless communication network 4. Note that the PC portal site management device 6 and the mobile portal site management device 7 may be operated by the same service provider. The management device 1 is also connected to a digital signage 8 via the Internet 2. The digital signage 8 (not shown) is an electronic device providing a communication function for transmitting and receiving data to and from the management device 1, a control function for controlling the entire operation, a display function, etc., and is set at the storefront of an advertisement provider, a place that attract everyone's attention or the like.

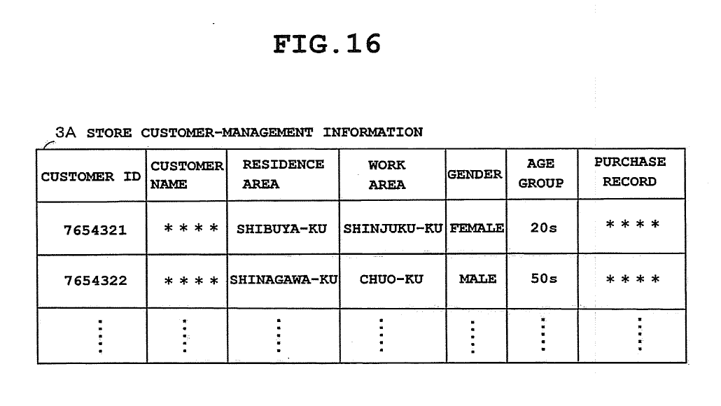

The store terminal 3 is a sales data processing device such as an ECR or a POS terminal that registers sales data for each transaction, in which advertisement application software (not shown) has been installed that provides an advertisement creating function for creating arbitrary advertisement data for the store itself, an advertisement delivery instructing function for instructing the management device 1 to deliver the created advertisement data to the advertising medium, etc. Here, the advertisement delivery instructing function is a transmitting function for transmitting a delivery instruction for advertisement data to the management device 1 via the Internet 2, in response to an instruction operation giving an instruction to deliver the store advertisement data. This store terminal 3 includes customer management information 3A shown in FIG. 16.

Note that the store terminal 3 is not limited to an ECR terminal or a POS terminal, and may be a PC set in the store or a mobile terminal (such as a multi-functional mobile phone referred to as a smart phone) of the person in charge of the store who works inside or outside the store. In addition, the store terminal 3 may also differ with each store. When using a PC or a mobile terminal as the store terminal 3, the store receives the advertisement application software that provides the advertisement creating function, the advertisement delivery instructing function and the like from the service provider or the like and installs it in the store terminal 3, as in the case of the sales data processing device described above. Also note that, although the advertisement application software has been installed in the case of the second embodiment, a web application, such as cloud computing, may be used in a case where the advertisement application software has not been installed.

The user terminal device 5 is a PC, a mobile terminal, or the like on the advertisement recipient side. In a case where the user terminal device 5 is a PC, when it is connected to the PC portal site management device 6 via the Internet 2, websites can be accessed and viewed, and mail magazines and the like can be received and acquired. Also, in a case where the user terminal device 5 is a multi-functional mobile phone referred to as a smart phone, when it is connected to the wireless communication network 4 from a nearby base station or switchboard (not shown), high speed and high volume communication with other mobile phones (not shown) can be performed via the wireless communication network 4. When the user terminal device 5 is connected to the Internet 2 via the wireless communication network 4, websites can be accessed and viewed. In a case where the user terminal device 5 is a mobile terminal, it includes a GPS function for acquiring the current position of the user terminal device 5 using reception radio waves from a GPS satellite (not shown).

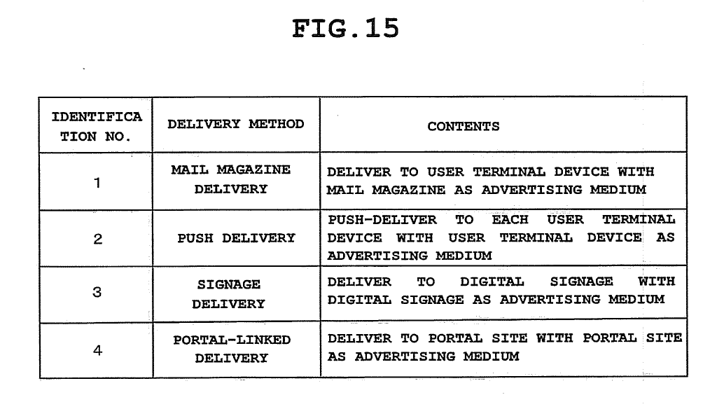

FIG. 15 is a diagram for describing plural types of delivery methods regarding how store advertisement data is delivered and to which type of advertising media it is delivered.

When the management device 1 is instructed by the store terminal 3 to deliver the advertisement data of the store, the management device 1 delivers the advertisement data to a predetermined advertising medium in response to this delivery instruction. When delivering, if an arbitrary delivery method has been selected from plural types of delivery methods (“mail magazine delivery”, “push delivery”, “signage delivery” and “portal-linked delivery” described hereafter) on the store terminal 3 side, the management device 1 delivers the advertisement data to an advertising medium of a type according to the selected delivery method.

As shown in FIG. 15, a delivery method having identification information “1” is “mail magazine delivery” in which advertisement data is delivered to each user terminal device 5 by electronic mail (mail magazine) serving as an advertising medium. That is, a mail magazine is used as an advertising medium. The management device 1 that has received advertisement data from the store terminal 3 delivers a mail magazine including the advertisement to the user terminal device 5. Specifically, the management device 1 references the store customer-management information 3A shown in FIG. 16, specifies a mail transmission destination to be a delivery target based on the attributes, purchase records, and the like of the customers, and delivers a mail magazine including advertisement to the user terminal device 5 of the transmission destination.

In this instance, the URL of the store website is inserted in the advertisement data in the mail magazine, and the detailed contents of the advertisement can be checked at the store website by the URL being accessed. Note that, when delivering the mail magazine including the advertisement to the user terminal device 5, the management device 1 may make the delivery at a time specified in advance on the store terminal 3 side. In addition, the timing at which the detailed contents of the advertisement are placed on the store website is before the delivery of the mail magazine at the latest.

The above-described store customer-management information 3A, which is used to store and manage the attributes and sales record of each customer, includes a “customer ID” field, a “customer name” field, a “residence area” field, a “work area” field, a “gender” field, an “age group” field, a “purchase record” field and the like, as shown in FIG. 16. The “purchase record” indicates the total amount of purchases, the total number of purchase transactions, the frequency of purchases, service points, etc. In the example in FIG. 16, a customer is shown whose “customer ID” is “7654321”, “residence area” is “Shibuya-ku”, “work area” is “Shinjuku-ku”, “gender” is “female”, and “age group” is “20s”. In addition, a customer is shown whose “store ID” is “7654322”, “residence area” is “Shinagawa-ku”, the “work area” is “Chuo-ku”, the “gender” is “male”, the “age group” is “50s”.

The management device 1 receives and acquires the store customer-management information 3A periodically or at a predetermined timing. Note that the acquiring method therefor may be arbitrarily determined. For example, the management device 1 may receive and acquire the store customer-management information 3A periodically from the store. Also, the management device 1 may receive and acquire the store customer-management information 3A together with a delivery instruction for advertisement data when receiving the delivery instruction from the store terminal 3. Moreover, the management device 1 may receive and acquire the store customer-management information 3A by accessing the store terminal 3 when delivering advertisement data to an advertising medium. Note that, although the store customer-management information 3A is stored and managed on the store terminal 3 side in the example in the second embodiment, it may be stored and managed on the management device 1 side.

A delivery method having identification information “2” is “push delivery” in which advertisement data is push-delivered to each user terminal device 5 with the user terminal device 5 as an advertising medium. That is, it is a method in which the management device 1 that has received advertisement data from the store terminal 3 push-delivers the advertisement data to the user terminal device 5. When the store advertisement data push-delivered from the management device 1 is received, the user terminal device 5 judges whether or not the distance from the store location to the current position of the user terminal device 5 is within a predetermined range (such as a radius of 2000 m), and displays the advertisement data on a condition that the distance is within the predetermined range. In this instance, the above-described distance (2000 m) is arbitrarily specified on the store terminal 3 side, but is not limited thereto.

Specifically, the user terminal device 5 acquires its own current position using a GPS satellite, and judges whether or not it is positioned within the advertising distance from the store location, or in other words, whether or not the user of the user terminal device 5 is near the store. Then, when judged that the user terminal device 5 is within the advertising distance (near the store), message data, such as a notification stating “advertisement service: 1 new notification”, is displayed on the terminal screen of the user terminal device 5, as advertisement reception information indicating that advertisement data has been received. Note that an advertisement icon or the like may also be used as the advertisement reception information. As described above, the user terminal device 5 functions as an advertising medium displaying advertisement data, and the display timing of the contents of the received advertisement notification is based on whether or not the user terminal device 5 is within the advertising distance (near the store).

A delivery method having identification information “3” is “signage delivery” in which store advertisement data is delivered to the digital signage 8 with the digital signage 8 as an advertising medium, as shown in FIG. 15. That is, it is a method in which the management device 1 that has received advertisement data from the store terminal 3 delivers the advertisement data to the digital signage 8. Specifically, based on the store location, the management device 1 designates a digital signage 8 installed near the store, such as within a predetermined range (such as a radius of 2000 m) around the store, as a delivery target, and delivers the advertisement data to the delivery target. In this instance, the above-described distance (2000 m) is arbitrarily specified on the store terminal 3 side, but is not limited thereto.

A delivery method having identification information “4” is “portal-linked delivery” in which store advertisement data is delivered to the user terminal device 5 that has accessed a portal site, with the portal site (PC site or mobile site) as an advertising medium, as shown in FIG. 15. That is, it is a method in which, when advertisement data is placed on a portal site by the management device 1 that has received the advertisement data from the store terminal 3 delivering the advertisement data, and the user terminal device 5 of a site user accesses the portal site, the advertisement data is delivered to the user terminal device 5 in response to the accessing operation. Specifically, by accessing the portal site and performing store search, the user terminal device 5 receives and acquires the advertisement data (detailed contents) of stores near the current position, and then outputs the advertisement data. That is, the user terminal device 5 has a search instructing function for accessing a portal site and giving an instruction to perform store search, a detection result receiving function for receiving and acquiring advertisement data of stores near the current position which has been retrieved by the store search on the portal site side via a communication network, and a display function for displaying the received detection results. Note that the operators of the PC portal site and the mobile portal site may be the same service provider. Also note that, although stores near the current position of the user are searched in the second embodiment, stores to be searched on the portal site side are not limited to those near the current position and may be arbitrarily determined.

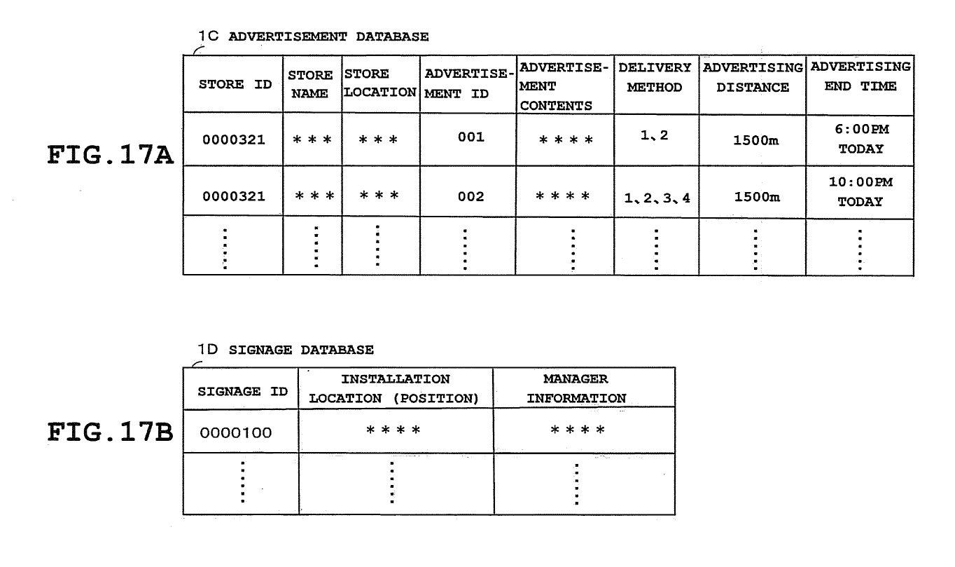

FIG. 17A is a diagram for describing the advertisement database 1C provided on the management device 1 side. The advertisement database 1C, which is used to register and manage advertisement data for which a delivery instruction has been given by the store terminal 3, includes a “store ID” field, a “store name” field, a “store location” field, an “advertisement ID” field, an “advertisement content” field, a “delivery method” field, an “advertising distance” field, an “advertising end time” field and the like. The “store ID” and the “store name” are information used to identify a member store, and the “store location” is longitude and latitude information indicating the location of the store. The “advertisement ID” is information used to identify a plurality of advertisement data for which delivery requests have been made from the same store.

The “advertisement contents” indicates advertisement data created on the store terminal 3 side, which may include a diagram or an image with text, or may be created having a handwritten appearance. The “delivery method” indicates a delivery method arbitrarily selected on the store side, from among the above-described “mail magazine delivery”, “push delivery”, “signage delivery” and “portal-linked delivery”. In the example in FIG. 17A, “1 and 2” are shown in the “delivery method” field, which indicates that “mail magazine delivery” whose identification information is “1” and “push delivery” whose identification information is “2” have been selected. “1 to 4” in the “delivery method” field indicates that “mail magazine delivery”, “push delivery”, “signage delivery” and “portal-linked delivery” respectively having the identification information “1” to “4” have all been selected. The “advertising distance”, which is a field set when the “push delivery” is selected, indicates an advertising target area (advertising range) arbitrarily specified on the store terminal 3 side. Specifically, this information indicates the radius of the advertising range in meters centering on the “store location”. Note that, in the second embodiment, the “advertising distance” can be arbitrarily specified within a range of 500 m to 2000 m.

The “advertising end time” refers to the ending time of advertisement specified on the store terminal 3 side.

In the example in FIG. 17A, two same values have been set in the “store ID” field. In the case of this store, the “delivery method” has been set to “1 and 2”, the “advertising distance” has been set to “1500 m”, and the “advertising end time” has been set to “6:00 pm today” for advertisement data whose “advertisement ID” is “001”. In addition, for advertisement data whose “advertisement ID” is “002”, the “delivery method” has been set to “1, 2, 3, and 4”, the “advertising distance” has been set to “1500 m” and the “advertising end time” has been set to “10:00 pm today”. Note that the “advertising end time” is not limited to time and may be “advertising end date” including a date or a day of the week.

FIG. 17B is a diagram for describing the signage database 1D provided on the management device 1 side. The signage database 1D, which is used to register and manage information related to the digital signage 8, includes a “signage ID” field, an “installation location (position)” field, a “manager information” field and the like. The “signage ID” is information used to identify the digital signage 8, and the “installation location (position)” is positional information (longitude and latitude information) of a location where the digital signage 8 has been installed. The management device 1 searches the signage database 1D based on the store location of an advertisement provider, and designates a digital signage 8 installed near the store (such as within a radius of 2000 m) as a delivery target for the advertisement data. The “manager information” is information related to the manager of the digital signage 8, and includes name, transmission destination address for making contact, phone number, address, etc.

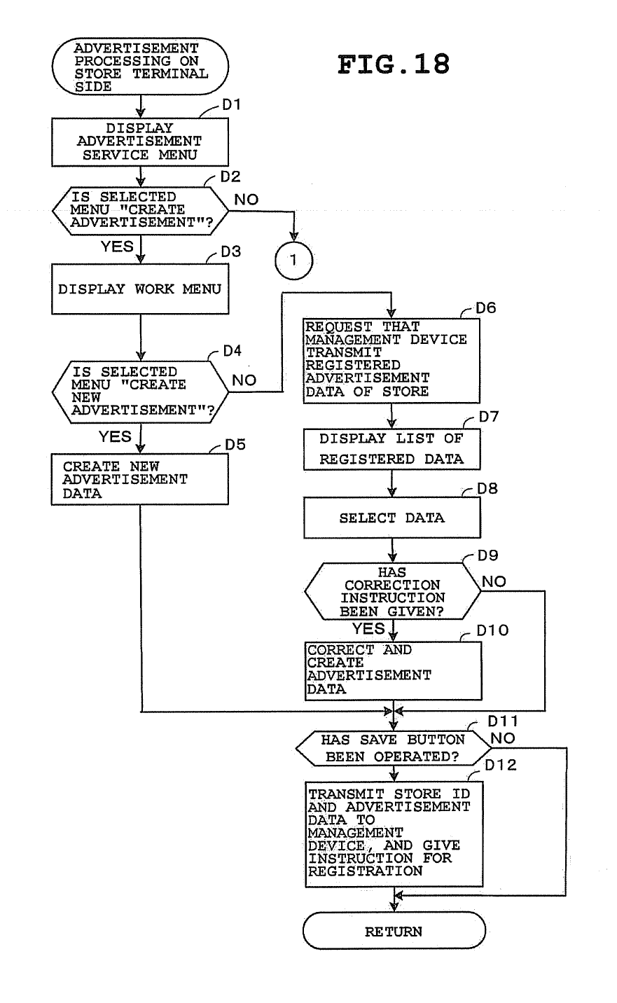

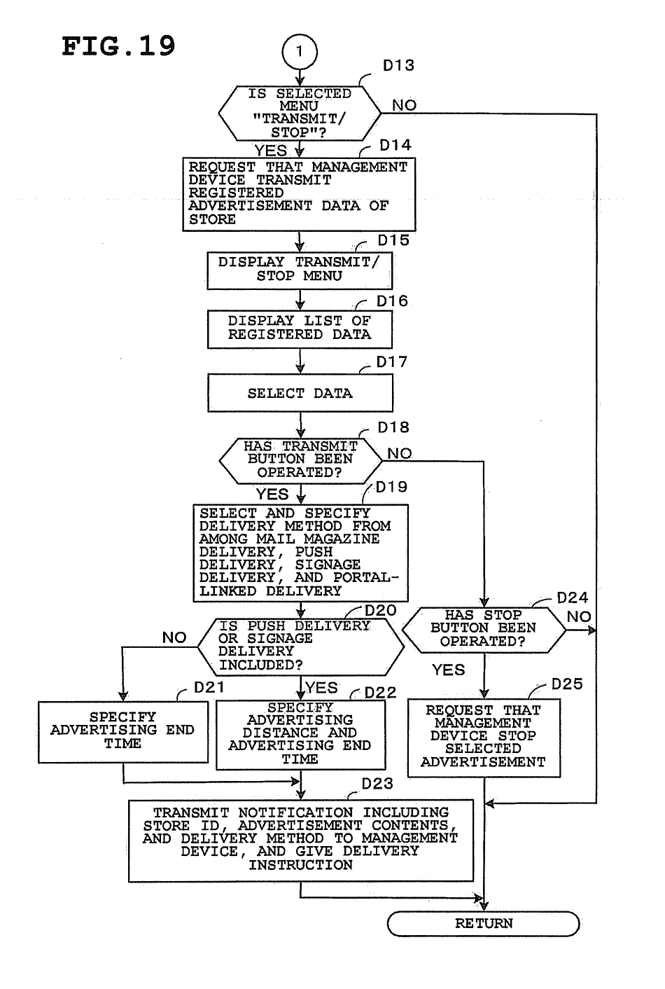

Next, the operational concept of the advertisement system according to the first embodiment will, be described with reference to the flowcharts shown in FIG. 18 to FIG. 20. Here, each function described in the flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. Note that FIG. 18 and FIG. 19 are flowcharts outlining operations of the characteristic portion of the first embodiment from among all of the operations of the store terminal 3. After exiting the flows in FIG. 18 and FIG. 19, the procedure returns to the main flow (not shown) of the overall operation.

These flowcharts in FIG. 18 and FIG. 19 show operations of the store terminal 3 that are started when an “advertisement processing” field is selected from the processing menu of the store terminal 3. First, the CPU 31 of the store terminal 3 displays an advertisement service menu on the touch input display section 34 (Step D1 in FIG. 18). This advertisement service menu is a menu screen including a “create advertisement” field for requesting the creation of advertisement data and a “transmit/stop” field for requesting the transmission of advertisement data or the cancellation of advertisement during advertising. Then, when the “create advertisement” field is selected from the menu screen by a user operation (YES at Step D2), the CPU 31 switches the menu to display a work menu (Step D3). This work menu is a menu screen including a “create new advertisement” field for requesting the creation of new advertisement data and a “use past advertisement” field for requesting the use of advertisement data created in the past.

When the “create new advertisement data” field is selected from the work menu by a user operation (YES at Step D4), the CPU 31 proceeds to new advertisement data creation processing (Step D5). In the new advertisement data creation processing, the user creates advertisement data by inputting text, symbols, diagrams and the like using an advertisement material (such as a diagram, text or an image) arbitrarily selected from advertisement materials prepared in advance, or various software keys (touch keys) allocated and displayed on the touch input display section 34, or by performing handwriting input on the touch input display section 34 to create advertisement data including a handwritten image. The created advertisement data can be colored or modified. Note that the advertisement data may be created using business type-specific templates or a wizard format.

Conversely, when the “use past advertisement” field is selected from the work menu screen by a user operation (NO at Step D4), the CPU 31 performs processing to request the transmission of the registered advertisement data of the user's own store (Step D6). When the registered advertisement data transmitted from the management device 1 in response to the request is received, the CPU 31 displays the advertisement data in a list (Step D7). This advertisement list screen displays (such as by thumbnail display) a list of various advertisement data registered in advance on the management device 1 side for use by the store. Then, when desired advertisement data is selected from the list screen by a user operation (Step D8), the CPU 31 judges whether or not an instruction to correct this advertisement data has been given (Step D9). Here, when the selected advertisement data is data whose contents can be used every day, such as “Today's Time-Limited Sale: Beer Half Off from 5:00 pm to 6:00 pm!”, correction is not required and therefore a correction instruction is not given. However, when a correction instruction is given to change the service contents, time, or the like (YES at Step D9), the CPU 31 proceeds to edit processing and creates desired advertisement data by correcting and editing the selected data (Step D10).

When new advertisement data is created (Step D5) or the selected advertisement data is corrected (Step D10) as described above, or when an instruction is given to reuse the selected advertisement data as it is, the CPU 31 proceeds to subsequent Step D11, and judges whether or not the save button (not shown) of the work menu has been operated. When judged that the save button has not been operated (NO at Step D11), the CPU 31 exits the flow in FIG. 18 and FIG. 19 to invalidate the currently created or selected data. When judged that the save button has been operated (YES at Step D11), the CPU 31 performs processing for transmitting the store ID and the advertisement data to the management device 1 and requesting the registration thereof. (Step D12), and exits the flows in FIG. 18 and FIG. 19.

At Step D2, when the “create advertisement” field is not selected from the above-described advertisement service menu (NO at Step D2), the CPU 31 proceeds to the flow in FIG. 19 and judges whether or not the “transmit/stop” field has been selected. When judged that the return button (not shown) of the advertisement service menu has been operated, the CPU 31 exits the flows in FIG. 18 and FIG. 19. When judged that the “transmit/stop” field has been selected (YES at Step D13), the CPU 31 performs processing to request the transmission of the registered advertisement data of the user's own store (Step D14). Then, when the registered advertisement data is received from the management device 1 in response to the request, the CPU 31 displays a transmit/stop menu (Step D15). This transmit/stop menu is a menu screen including a transmit button for giving an instruction to deliver advertisement data and a stop button for giving an instruction to stop the outputting of advertisement data. Then, the CPU 31 displays a list of the received registered advertisement data of the user's own store in the transmit/stop menu (Step D16).

Subsequently, when advertisement data desired by the user is selected from this advertisement list screen in the transmit/stop menu (Step D17), the CPU 31 judges whether or not the transmit button has been operated (Step D18) and whether or not the stop button has been operated (Step D24). When judged that the transmit button has been operated (YES at Step D18), the CPU 31 displays, for example, a transmission menu screen, and the user selects and specifies a desired delivery method based on the status of the store, the advertisement contents, etc., from among the delivery methods “mail magazine delivery”, “push delivery”, “signage delivery” and “portal-linked delivery” displayed within the menu (Step D19). In this selection, not only one of “mail magazine delivery”, “push delivery”, “signage delivery” and “portal-linked delivery”, but also two or more of them may be selected in combination, or all of them may be selected.

Then, the CPU 31 judges whether or not “push delivery” or “signage delivery” is included in the selected delivery methods (Step D20). When judged that “push delivery” or “signage delivery” is included therein (YES at Step D20), the CPU 31 waits for the user to specify an “advertising distance” and an “advertising end time” therefor (Step D22). Conversely, when judged that neither “push delivery” nor “signage delivery” is included (NO at Step D20), the CPU 31 waits for the user to specify an “advertising end time” (Step D21). Note that, when specifying an “advertising distance” in association with “push delivery” or “signage delivery”, the user decides a distance from the store that serves as the advertising range based on the status of the store, the advertisement contents, etc., and inputs the advertising distance by the touch input display section 34.

Also, when specifying an “advertising end time”, the user decides the end time for advertising, and inputs the advertising end time by the touch input display section 34. Then, the CPU 31 creates a notification including the advertisement contents of the arbitrarily selected advertisement data, the arbitrarily specified delivery method, the advertising distance, the advertising end time, etc., and transmits an delivery instruction for this notification to the management device 1 (Step D23). At Step D24, when judged that the stop button has been operated (YES at Step D24), the CPU 31 transmits an instruction to stop the advertisement to the management device 1 (Step D25).

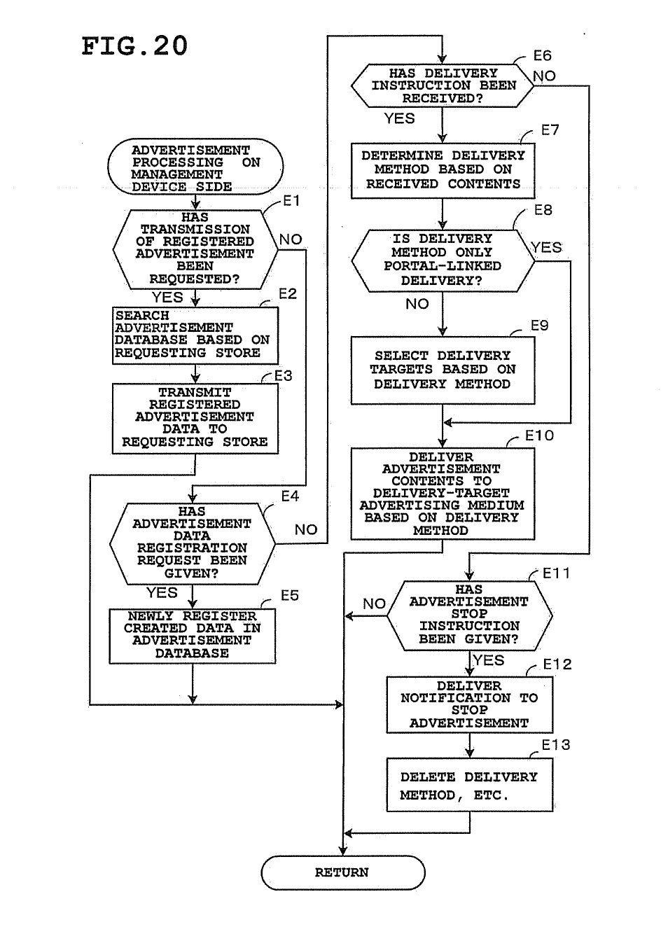

FIG. 20 is a flowchart showing operations of the management device 1 which are started in response to a request or an instruction from the store terminal 3. After exiting the flow in FIG. 20, the procedure returns to the main flow (not shown) of the overall operation.

First, when a request or an instruction from the store terminal 3 is received, the management device 1 judges whether or not the transmission of the advertisement data of the requesting store has been requested (Step E1). When judged that the transmission of the advertisement data has been requested (YES at Step E1), the CPU 11 searches the advertisement database 1C based on the requesting store (store ID) (Step E2), and after reading out all advertisement data registered in association with the store, transmits the advertisement data to the requesting store terminal 3 (Step E3). Note that, in a case where the owner is operating a plurality of stores, such as chain stores, advertisement data registered in association with the plurality of stores may be read out and transmitted. Also, when the registration of advertisement data created by the store terminal 3 is requested (YES at Step E4), the CPU 11 registers the “store ID”, the “store name” and the “store location” based on the requesting store, and after registering the created data as “advertisement contents”, registers a new “advertisement ID” by updating the “advertisement ID” of the store (Step E5).

Also, when a delivery instruction for advertisement data is received from the store terminal 3 (YES at Step E6), the CPU 11 determines a “delivery method” selected on the store side (Step E7), and judges whether or not the “delivery method” is only “portal-linked delivery” (Step E8). That is, the CPU 11 judges whether or not a delivery method other than “portal-linked delivery” is included in the selected “delivery method”. When judged that the selected “delivery method” is only “portal-linked delivery” (YES at Step E8), the CPU 11 skips the subsequent delivery target selection processing (Step E9), and proceeds to Step E10. Conversely, when judged that a delivery method other than “portal-linked delivery” is included (NO at Step E8), the CPU 11 proceeds to selection processing for selecting delivery-target members based on the delivery method (Step E9).

That is, when the “delivery method” is “mail magazine delivery”, the CPU 11 references the store customer-management information 3A, and selects mail transmission destinations that serves as delivery targets, based on the attributes, purchase records and the like of the customers. Also, when the “delivery method” is “push delivery”, the CPU 11 references the member database 1B, and selects delivery-target members based on the location of the store and the residence areas or the work areas of the member users. For example, the CPU 11 searches the member store database 1A based on the store that has given the delivery instruction, and after identifying the delivery-target area based on the store location, selects member users whose residence areas or work areas correspond to the identified area as delivery targets. Also, when the “delivery method” is “signage delivery”, the CPU 11 searches the signage database 1D based on the store location, and designates a digital signage 8 installed near the store (such as within a 2000 m radius) as a delivery target.

Then, the CPU 11 proceeds to Step E10, and delivers the advertisement contents and the like to a delivery-target advertising medium based on the selected delivery method. Here, when the selected “delivery method” is “mail magazine delivery”, the management device 1 delivers the advertisement data to the user terminal device 5 selected as the delivery target. The user terminal device 5 side can check the detailed contents of the advertisements at the store website, by accessing the URL of the store website inserted in the advertisement included in the mail magazine. In this case, the advertisement data is placed in the mail magazine until the above-described advertising end time. That is, the advertisement data is no longer placed in the mail magazine when the advertising end time is reached.

When the selected “delivery method” is “push delivery”, the management device 1 delivers the advertisement data to the user terminal device 5 selected as the delivery target. The user terminal device 5 side displays the advertisement data on a condition that the distance from the store location to its current position is within a predetermined range. Note that the display of the advertisement data is deleted when the above-described advertising end time is reached.

When the selected “delivery method” is “signage delivery”, the management device 1 delivers the advertisement data to the digital signage 8 selected as the delivery target. In this case, the advertisement data is displayed on the digital signage 8 near the advertising store, and the display of the advertisement data is deleted when the above-described advertising end time is reached. Also, when the selected “delivery method” is “portal-linked delivery”, the management device 1 delivers the advertisement data to the portal site management devices 6 and 7, and the advertisement data is placed on the respective portal sites thereof. Then, when the user terminal device 5 of a site user accesses the site and performs a store search, the advertisement data (detailed contents) of each store near the current position of the user terminal device 5 is displayed on the terminal screen of the user terminal device 5. In this case, the advertisement data is placed on the portal sites until the above-described advertising end time. That is, the advertisement data is no longer placed on the portal sites when the advertising end time is reached.

Also, when an advertisement stop instruction is received from the store terminal 3 (YES at Step E11), the CPU 11 delivers a notification giving an instruction to stop the advertisement to the above-described delivery targets (Step E12). Subsequently, the CPU 11 deletes the “delivery method”, the “advertising distance” and the “advertising end time” of the advertisement for which the notification to stop has been delivered, from the advertisement database 1C (Step E13). Then, the CPU 11 ends the flow in FIG. 20. Here, when the delivery method is “mail magazine delivery” or “portal-linked delivery”, the placement of the advertisement data in the mail magazine or the portal sites is stopped. When the delivery method is “push delivery” or “signage delivery”, the display of the advertisement and the like are stopped at this point.

As described above, in the second embodiment, when an arbitrary delivery method is selected from among a plurality of delivery methods regarding how store advertisement data is delivered and to which type of advertising media it is delivered, and an operation giving an instruction to deliver advertisement data is performed, the store terminal 3 constituting the advertisement delivery service transmits to the management device 1, a delivery instruction giving an instruction to deliver the advertisement data by the selected delivery method. Then, when the delivery instruction is received from the store terminal 3, the management device 1 delivers the advertisement data for which the instruction has been given to the advertising medium of the selected delivery method in accordance with the selected delivery method. Therefore, the type of advertising media to be used and the method of delivery can be specified based on the status of the store by which advertisement having a high customer attraction effect can be actualized. Thus, the present invention is highly useful.

That is, timely advertisement can be freely made at anytime based on the current status of the store, such as the store having few customers, the store having received a large stock of products, the store having poor sales, an event being held in the neighborhood, a competitor store being crowded, pedestrian traffic suddenly increasing, rain and the like. In this instance, the creation, selection and transmission of advertisement data on the store side, the database processing and delivery of the advertisement data on the service provider side, and the reception of the advertisement data and judgment regarding the display thereof on the end user side are all performed using digital data. Therefore, unlike conventional advertising media using paper, such as flyers and posters, advertisements from a store that has requested an advertisement service can be transmitted to the end users in a short amount of time that is close to real-time.

Also, when the delivery method “push delivery” is selected on the store terminal 3 side, the user terminal device 5, which has received the advertisement data from the store terminal 3 via the management device 1, judges whether or not the distance from the store location to its current position is within a predetermined range, and outputs the advertisement data on a condition that the distance is within the predetermined range. As a result of this configuration, real-time advertising can be made to an area surrounding the store (to potential customers who can be immediately attracted). In addition, unnecessary notifications and annoying notifications to member users in locations other than those near the store can be avoided. Moreover, since advertisements are delivered from a plurality of member stores of the advertisement delivery service, there is a benefit to the member users in that they can receive sale information from many stores, unlike the membership of one store. Note that a configuration may be adopted whereby users who have downloaded the advertisement application are included as the service subscribers in addition to the member users. Since advertisements are transmitted to the subscribers of the advertisement delivery service regardless of whether or not they have the membership of the store, this configuration gives benefit to the member stores in that they can give notifications to a greater number of end users.

Also, when the delivery method “signage delivery” is selected on the store terminal 3 side, the management device 1 delivers the advertisement data to the digital signage 8 near the store, based on the store location. As a result of this configuration, real-time advertising can be made to an area surrounding the store (to potential customers who can be immediately attracted) with the digital signage 8 as an advertising medium.

Also, when the delivery method “portal-linked delivery” is selected on the store terminal 3 side, the management device 1 delivers the advertisement data to the portal site management devices 6 and 7, and the advertisement data is placed on the respective portal sites thereof. Then, by accessing the portal site and performing store search, the user terminal device 5 receives and acquires the advertisement data of stores near the current location, and outputs the advertisement data. As a result of this configuration on the store side, real-time advertising can be performed to an area surrounding the store (to potential customers who can be immediately attracted). On the end user side, not only store members but anyone can freely acquire sale information of surrounding stores as required, simply by accessing the portal sites.

Also, when the delivery method “mail magazine delivery” is selected on the store terminal 3 side, the management device 1 determines the transmission destination of the mail magazine with reference to the store customer-management information 3A, and delivers an electronic mail including the advertisement data to the user terminal device 5 of the transmission destination. As a result of this configuration, real-time advertising can be performed to potential customers who can be immediately attracted, based on customer attributes, purchase records, and the like, and the customers can acquire the sale information by viewing the mail magazine when necessary.

Moreover, the store terminal 3 has an advertisement data creating function, and transmits advertisement data created by the creating function to the management device 1, together with a delivery instruction. Therefore, advertisement data having appropriate contents can be immediately created based on the status of the store. For example, when an event is being held near the store, the store can create advertisement data corresponding to the event contents, whereby the customer attraction effect is enhanced.

Furthermore, in the first embodiment, the management device 1 receives and registers advertisement data created by the store terminal 3, and transmits the store advertisement data in response to a request from the store terminal 3. Therefore, the store can reuse the created advertisement data as is, or can use the created advertisement data by correcting or editing a portion thereof, which effectively makes the creating operation easier and faster.

Still further, when the store terminal 3 transmits an advertising end time to the management device 1 together with a delivery instruction for the advertisement data, and the management device 1 delivers the advertising end time to an advertising medium according to the delivery method, the advertising medium displays the advertisement data on a condition that the advertising end time has not been reached. As a result of this configuration, only currently valid advertisements can be displayed, which is advantageous for limited-time sale advertisements and the like.

Yet still further, the store terminal 3 can give an instruction to stop advertising. As a result of this configuration, advertisement can be freely stopped at any time based on the current status of the store, such as the store having many customers by the advertising effect, the store having a low stock of products, a nearby event ending, and the like, by which advertisement that reflects the intentions of the store can be made.

Note that the delivery methods from which an arbitrary delivery method is selected in the above-described second embodiment are not limited to “mail magazine delivery”, “push delivery”, “signage delivery” and “portal-lined delivery”, and may be arbitrarily determined.

In addition, although the advertising distance is a range centering on a store location in the second embodiment, an area including an entertainment district nearest to the store, nearby train and bus stations, colleges, event venues and the like may be the advertising range. Alternatively, the distance from the store to the user of the user terminal device 5 may be considered within the predetermined range (nearby range).

Moreover, in the second embodiment, advertisement data is created on the store side. However, a configuration may be adopted in which the store side can make a request for the creation of advertisement data to the service provider side, in addition to creating advertisement data on its own side.

Furthermore, although an advertising end time is specified and transmitted to the management device 1 in the second embodiment, an advertising start time and an advertising end time may be specified and transmitted to the management device 1.

Still further, the user terminal device 5 is not limited to a smart phone, and may be a digital camera (compact camera), a PDA, a portable music player, a portable gaming device, etc.

Yet still further, the “devices” or the “sections” described in the second embodiment are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An advertisement delivery system that transmits advertisement data of a store via a communication network, comprising:
a store terminal;
a management device connected to the store terminal via the communication network; and
a mobile terminal connected to the management device via the communication network,
wherein the store terminal comprises a transmitting section which transmits a delivery instruction to the management device in response to an operation giving an instruction to deliver advertisement data,
wherein the management device comprises a delivering section which push-delivers to the mobile terminal the advertisement data of the store giving the delivery instruction, when the delivery instruction transmitted from the store terminal is received, and
wherein the mobile terminal comprises:
a judging section which judges whether a distance from the store giving the delivery instruction to a current position of the mobile terminal is within a predetermined range, when the advertisement data of the store giving the delivery instruction which has been push-delivered from the management device is received; and
an outputting section which outputs the advertisement data on a condition that the judging section has judged that the distance is within the predetermined range.

2. The advertisement delivery system according to claim 1, wherein the store terminal further comprising:
a creating section which creates the advertisement data, and the transmitting section transmits the advertisement data created by the creating section to the management device.

3. The advertisement delivery system according to claim 2, wherein the management device further comprising:
a registering section which receives and registers the advertisement data created by the creating section of the store terminal; and
a transmitting section which, when a request to transmit the advertisement data registered by the registering section is made by the store terminal, transmits the advertisement data registered in association with the store to the store terminal that has made the request.

4. The advertisement delivery system according to claim 1, wherein the delivering section of the management device delivers to the mobile terminal the advertisement data of the store giving the delivery instruction together with positional information of the store giving the delivery instruction, and
wherein the mobile terminal further comprises a position acquiring section which acquires positional information of the mobile terminal, and
wherein the judging section judges whether the distance from the store giving the delivery instruction to the current position of the mobile terminal is within the predetermined range based on the positional information of the mobile terminal acquired by the position acquiring section and the positional information of the store giving the delivery instruction which has been delivered from the management device.

5. The advertisement delivery system according to claim 1, wherein the store terminal further comprising:
an end specifying section which specifies an advertising end time, in which the transmitting section transmits the advertising end time specified by the end specifying section to the management device,
wherein the management device delivers the advertising end time received from the store terminal to the mobile terminal, and
wherein the mobile terminal further comprises:
a clocking section which clocks current time,
wherein the judging section further judges whether end of advertising has been reached based on the advertising end time received from the management device and the current time clocked by the clocking section, and
wherein the outputting section outputs the advertisement data on a condition that the judging section has judged that the distance is within the predetermined range and the end of advertising has not been reached.

6. The advertisement delivery system according to claim 1, wherein the transmitting section of the store terminal further transmits, to the management device, a stop instruction giving an instruction to deliver an advertisement stop instruction, in response to an instruction operation giving an instruction to stop advertisement, and
wherein the outputting section of the mobile terminal stops output of the advertisement data of the store that has given the stop instruction, when the stop instruction from the store terminal is received.

7. The advertisement delivery system according to claim 1, wherein the management device, when delivering to the mobile device the advertisement data of the store giving the delivery instruction, specifies a delivery target based on positional information of the store giving the delivery instruction, and a residence area or a work area of a user of the mobile terminal, and delivers the advertisement data to the mobile terminal of the specified delivery target.

8. The advertisement delivery system according to claim 1, wherein the management device, when delivering to the mobile device the advertisement data of the store giving the delivery instruction, specifies a delivery target based on attributes of the store giving the delivery instruction and attributes of a user of the mobile terminal, and delivers the advertisement data to the mobile terminal of the specified delivery target.

9. A store terminal comprising:
a connecting section which communicably connects with a management device that delivers advertisement data of a store to a mobile terminal via a communication network;
a first transmitting section which transmits to the management device a delivery instruction giving an instruction to push-deliver the advertisement data to the mobile terminal in response to an instruction operation giving an instruction to deliver the advertisement data of the store; and
a second transmitting section which transmits to the management device a delivery instruction giving an instruction to deliver information required for judgment to the mobile terminal that judges whether a distance from the store to a current position is within a predetermined range and outputs the advertisement data on a condition that the distance is within the predetermined range, when the delivery instruction for the advertisement data transmitted from the first transmitting section is received via the management device.

10. The store terminal according to claim 9, further comprising:
a creating section which creates the advertisement data of the store,
wherein the first transmitting section transmits to the management device the advertisement data of the store created by the creating section together with the delivery instruction for the advertisement data.

11. The store terminal according to claim 9, further comprising:
a third transmitting section which transmits to the management device a stop instruction giving an instruction to deliver an advertisement stop instruction, in response to an instruction operation giving an instruction to stop advertisement, after the first transmitting section transmits the delivery instruction for the advertisement data.

12. A non-transitory computer-readable storage medium having stored thereon a program that is executable by a computer, the program being executable by the computer to perform functions comprising:
processing for communicably connecting with a management device that delivers advertisement data of a store to a mobile terminal via a communication network;
processing for transmitting to the management device a delivery instruction giving an instruction to push-deliver the advertisement data to the mobile terminal in response to an instruction operation giving an instruction to deliver the advertisement data of the store; and
processing for transmitting to the management device a delivery instruction giving an instruction to deliver information required for judgment to the mobile terminal that judges whether a distance from the store to a current position is within a predetermined range and outputs the advertisement data on a condition that the distance is within the predetermined range, when the transmitted delivery instruction for the advertisement data of the store is received via the management device.

13. The advertisement delivery system according to claim 1, wherein the store terminal further comprising:
a selecting section which selects an arbitrary delivery method from among a plurality of delivery methods regarding how the advertisement data of the store is delivered and to which type of advertising medium the advertisement data is delivered, and
wherein the transmitting section transmits to the management device a delivery instruction giving an instruction to deliver the advertisement data by the delivery method selected by the selecting section, in response to the operation giving the instruction to deliver the advertisement data, and
wherein the delivering section of the management device delivers the advertisement data for which the delivery instruction has been given to an advertising medium of the selected delivery method in accordance with the selected delivery method, when the delivery instruction transmitted from the store terminal is received.

14. The advertisement delivery system according to claim 13, wherein one of the plurality of delivery methods is a method in which the management device which has received the advertisement data from the store terminal push-delivers the advertisement data to the mobile terminal with the mobile terminal as the advertising medium; and
wherein the mobile terminal judges whether the distance from the store to the current position of the mobile terminal is within the predetermined range and outputs the advertisement data on the condition that the distance is within the predetermined range, when the advertisement data of the store push-delivered from the management device is received.

15. The advertisement delivery system according to claim 13, wherein one of the plurality of delivery methods is a method in which the management device which has received the advertisement data from the store terminal delivers the advertisement data to a digital signage with the digital signage as the advertising medium; and
wherein the delivering section of the management device delivers the advertisement data to a digital signage near the store, based on a location of the store.

16. The advertisement delivery system according to claim 13, wherein one of the plurality of delivery methods is a method in which, when the management device which has received the advertisement data from the store terminal delivers the advertisement data via the communication network and the advertisement data is placed on a site on the communication network with the site as the advertising medium, the advertisement data is delivered to the mobile terminal in response to the site being accessed from the mobile terminal on a site user side; and
wherein the mobile terminal comprises:
a search instructing section which accesses the site and gives an instruction to perform store search; and
a detection result receiving section which receives advertisement data of a store near the current position which has been found by the store search on the site side via the communication network,
wherein the outputting section outputs search results received from the detection result receiving section.

17. The advertisement delivery system according to claim 13, wherein one the plurality of delivery methods is a method in which the management device which has received the advertisement data from the store terminal delivers an electronic mail including the advertisement data via the communication network, with the electronic mail as the advertising medium, and
wherein the delivering section of the management device determines a transmission destination of the electronic mail with reference to store customer-management information, and delivers the electronic mail including the advertisement data to the mobile terminal of the transmission destination.

18. The advertisement delivery system according to claim 13, wherein the management device further comprising:
a registering section which receives and registers advertisement data created by a creating section of the store terminal; and
a sending section which, when a request to transmit the advertisement data registered by the registering section is made by the store terminal, sends the advertisement data registered in association with the store to the store terminal that has made the request.

19. The advertisement delivery system according to claim 13, wherein the store terminal further comprising:
a specifying section which specifies an advertising end time, and transmits the advertising end time specified by the specifying section to the management device, and
wherein the delivering section of the management device delivers the advertising end time received from the store terminal to the advertising medium of the selected delivery method, in accordance with the selected delivery method, and
wherein the advertising medium outputs the advertisement data on a condition that the advertising end time received from the management device has not been reached.

20. The advertisement delivery system according to claim 13, wherein the store terminal further transmits a stop instruction giving an instruction to deliver an advertisement stop instruction, in response to an instruction operation giving an instruction to stop advertisement,
wherein the delivering section of the management device delivers the stop instruction received from the store terminal to the advertising medium of the selected delivery method, in accordance with the selected delivery method; and
wherein the advertising medium stops output of the advertisement data of the store that has given the stop instruction, when the stop instruction from the store terminal is received.
